(19) United States
(12) Patent Application Publication
(10) Pub. No.: US 2022/0393865 A1
(43) Pub. Date: Dec. 8, 2022

(54) A SYSTEM AND METHOD FOR SATELLITE QUANTUM KEY DISTRIBUTION

(71) Applicant: Arqit Limited, London (GB)

(72) Inventors: David Williams, Surrey (GB); David Bestwick, Essex (GB); Barry Childe, Sussex (GB); Andrew James Victor Yeomans, Hertfordshire (GB); Omar Iqbal, Hampshire (GB)

(21) Appl. No.: 17/775,201

(22) PCT Filed: Nov. 6, 2020
(86) PCT No.: PCT/GB2020/052827

§ 371 Date: May 6, 2022

(30) Foreign Application Priority Data
Nov. 8, 2019 (GB) 1916308.8

(51) Int. Cl. H04L 9/08; H04B 7/185; H04B 10/70

(52) U.S. Cl. CPC H04L 9/0855; H04B 7/1851; H04B 10/70

(57) ABSTRACT

A method of scheduling and managing key data in a satellite quantum key distribution system comprising a constellation of one or more satellites and a plurality of user ground stations. The method comprises: using a satellite of the constellation of satellites to deliver key data to a user ground station using a quantum communication link; at the user ground station, storing the delivered key data and reporting the amount of delivered key data; using the satellite to deliver key data to at least one other user ground station requiring common encryption keys with the user ground station using a respective quantum communication link; at each other user ground station, storing the delivered key data and reporting the amount of delivered key data; based upon the reports, determining an amount of the delivered key data which is commonly stored at all of the user ground station and the at least one other user ground station; and instructing the user ground station and the at least one other user ground station to release the commonly stored delivered key data

The present application relates to a method of controlling key distribution in a satellite quantum key distribution system, and a system and software for carrying out the method.

### BACKGROUND

Cryptography is used to protect billions of transactions every day from, without limitation, for example Transport Layer Security (TLS) security for online shopping and banking to ultra-secure government communications. These transactions rely on reliable and secure means for at least two or more transacting parties to share a secret key, enabling encryption of data by one party and subsequent decryption by the other party(ies). When commercially usable universal quantum computers become available, a variety of these types of transactions, tasks and applications including, without limitation, for example digital banking, web certification, Know Your own Client (KYC), digital asset transfer, and authentication will be vulnerable. These transactions, tasks and applications are currently provided using software systems that typically use conventional cryptography and/or encryption techniques and protocols that are not sufficiently resilient enough to withstand an attack from such quantum computers (QCs).

QCs can potentially crack many classical cryptography codes almost effortlessly. There has also been a ground swell in interest in quantum computing within the last year as a result of the success of D-Wave in selling commercial systems. Furthermore, a number of breakthroughs by technology companies such as, without limitation, for example Microsoft®, Intel®, Google® and others in QC techniques promise to make a universal QC viable in the near future (e.g. five to ten years time). QCs have already become a threat to current cryptography and/or encryption techniques.

For example, current methods to exchange cryptographic keys between two parties will be vulnerable to QC attack. If the cryptographic primitives involved in the key-exchange protocol can be broken, the exchanged key is compromised and the encrypted data is revealed to the attacker. Classical key-exchange protocols are based on the hardness of discrete logarithm problem (e.g. Diffie-Hellman (DH)) or the elliptic curve discrete logarithm problem (e.g. Elliptic-Curve DH (ECDH)). Neither of these problems is guaranteed to be hard and both problems can be broken by a QC in polynomial time. This is of particular concern to both large and small organisations, corporations and also to individual users of public and private networks (e.g. Internet or corporate Intranets). If one is unable to reliably perform key exchange, then all current transactions, tasks and applications are vulnerable to attack by a QC.

The field of “Quantum Cryptography” aims to address these risks by developing both quantum secure cryptographic algorithms (so-called quantum-safe algorithms) and Quantum Key Distribution (QKD) techniques. Whilst the combination of both provides the ultimate solution, QKD as a stand-alone technique still has much to offer and is not in itself reliant on the development of quantum-safe algorithms to become widely adopted. However, even reliably performing QKD at scale for a wide range of users from small to large corporations and/or individuals is still a costly and time consuming exercise.

There is a desire for a robust, secure and cost effective approach for carrying out QKD, and one approach which has been proposed is to carry out QKD between one or more satellites and users on the ground. However, it is difficult to ensure correct delivery of cryptographic keys from satellites to the different ground users in such a system.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a method of scheduling and managing key data in a satellite quantum key distribution system comprising a constellation of one or more satellites and a plurality of user ground stations, the method comprising: using a satellite of the constellation of satellites to deliver key data to a user ground station using a quantum communication link; at the user ground station, storing the delivered key data and reporting the amount of delivered key data; using the satellite to deliver key data to at least one other user ground station requiring common encryption keys with the user ground station using a respective quantum communication link; at each other user ground station, storing the delivered key data and reporting the amount of delivered key data; based upon the reports, determining an amount of the delivered key data which is commonly stored at all of the user ground station and the at least one other user ground station; and instructing the user ground station and the at least one other user ground station to release the commonly stored delivered key data.

In a second aspect, the present disclosure provides method of scheduling managing key data in a satellite quantum key distribution system comprising a constellation of one or more satellites and a plurality of user ground stations, the method comprising: delivering key data stored at a user ground station from the user ground station to a satellite of the constellation of satellites using a quantum communication link; at the user ground station, reporting the amount of delivered key data; at the satellite, storing the delivered key data; the satellite using the copy of the key data stored on the satellite to deliver the key data to at least one other user ground station requiring common encryption keys with the user ground station using a respective quantum communication link; at each other user ground station, storing the delivered key data and reporting the amount of delivered key data; based upon the reports, determining an amount of the delivered key data which is commonly stored at all of the user ground station and the at least one other user ground station; and instructing the user ground station and the at least one other user ground station to release the commonly stored delivered key data.

In a third aspect, the present disclosure provides a satellite quantum key distribution system comprising a constellation of one or more satellites and a plurality of user ground stations, the system comprising: a satellite of the constellation of satellites arranged to deliver key data to a user ground station using a quantum communication link; a user ground station arranged to store the delivered key data and report the amount of delivered key data; wherein the satellite is further arranged to deliver key data to at least one other user ground station requiring common encryption keys with the user ground station using a respective quantum communication link; and each at least one other user ground station is arranged to store the delivered key data and report the amount of delivered key data; and the system further comprising means arranged to, based upon the reports, determine an amount of the delivered key data which is commonly stored at all of the user ground station and the at least one other user ground station; and instruct the user ground station and the at least one other user ground station to release the commonly stored delivered key data.

In a fourth aspect, the present disclosure provides a satellite quantum key distribution system comprising a constellation of one or more satellites and a plurality of user ground stations, the system comprising: a satellite of the constellation of satellites arranged to deliver key data stored at a user ground station using a quantum communication link; a user ground station arranged to report the amount of delivered key data; wherein the satellite is further arranged to store the delivered key data and to use the copy of the key data stored on the satellite to deliver the key data to at least one other user ground station requiring common encryption keys with the user ground station using a respective quantum communication link; each at least one other user ground station arranged to store the delivered key data and report the amount of delivered key data; the system further comprising means arranged to, based upon the reports, determine an amount of the delivered key data which is commonly stored at all of the user ground station and the at least one other user ground station; and instruct the user ground station and the at least one other user ground station to release the commonly stored delivered key data.

In a fifth aspect, the present disclosure provides an apparatus comprising a processor unit, a memory unit and a communication interface, the processor unit connected to the memory unit and the communication unit, wherein the apparatus is configured to implement the computer-implemented method according to any of the first and second aspects.

In a sixth aspect, the present disclosure provides a computer-readable medium comprising code or computer instructions stored thereon, which when executed by a processor unit, causes the processor unit to perform the computer-implemented method according to any one of the first and second aspects.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram illustrating a satellite quantum key distribution system according to a first embodiment of the invention;

FIG. 2 is a schematic diagram of the system architecture of the satellite quantum key distribution system of FIG. 1;

FIG. 3 is a schematic diagram illustrating a first quantum key distribution methodology which can be used by the system of FIG. 1;

FIG. 4 is a schematic diagram illustrating an example of a sequence of actions taken in the first quantum key distribution methodology of FIG. 3;

FIG. 5 is an explanatory diagram illustrating an example of an encryption key lifecycle useable on the system of FIG. 1;

FIG. 6 is an explanatory diagram illustrating key management in the system of FIG. 1;

FIG. 7 is a schematic diagram of a key management system useable in the system of FIG. 1;

FIG. 8 is a schematic diagram of a method of operation of the key management system of FIG. 7;

FIG. 9 is a schematic diagram illustrating operation of the key management system of FIG. 7;

FIG. 10 is a schematic diagram of an example of a method of operation of the key management system of FIG. 7;

FIG. 11 is an explanatory diagram of the issue of formatted encryption keys to users by the system of FIG. 1; and

FIG. 12 is a schematic diagram illustrating a second quantum key distribution methodology which can be used by the system of FIG. 1.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

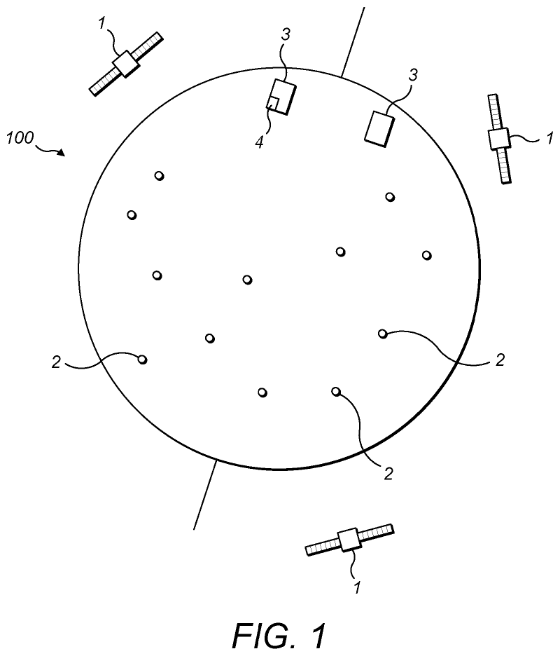

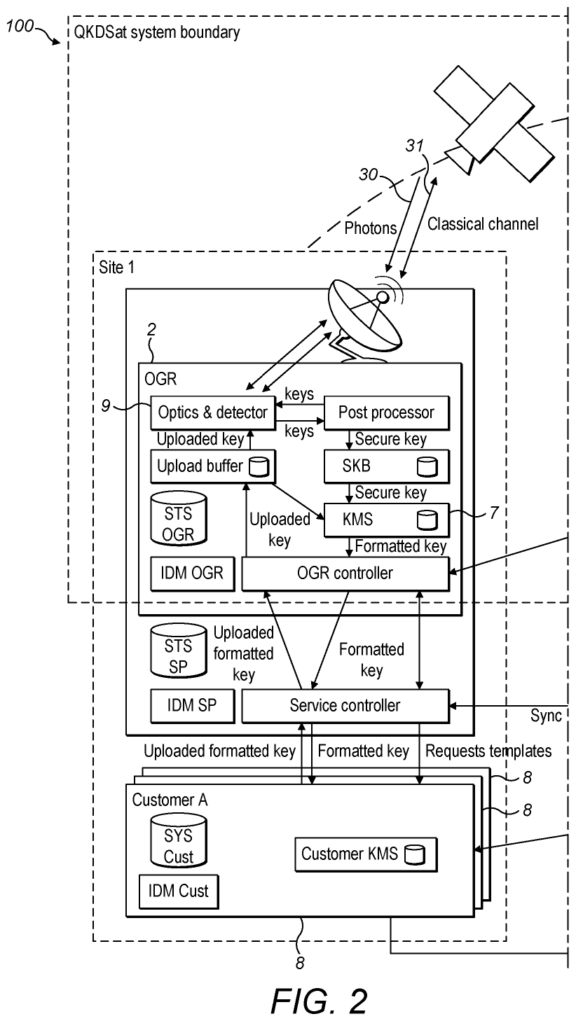

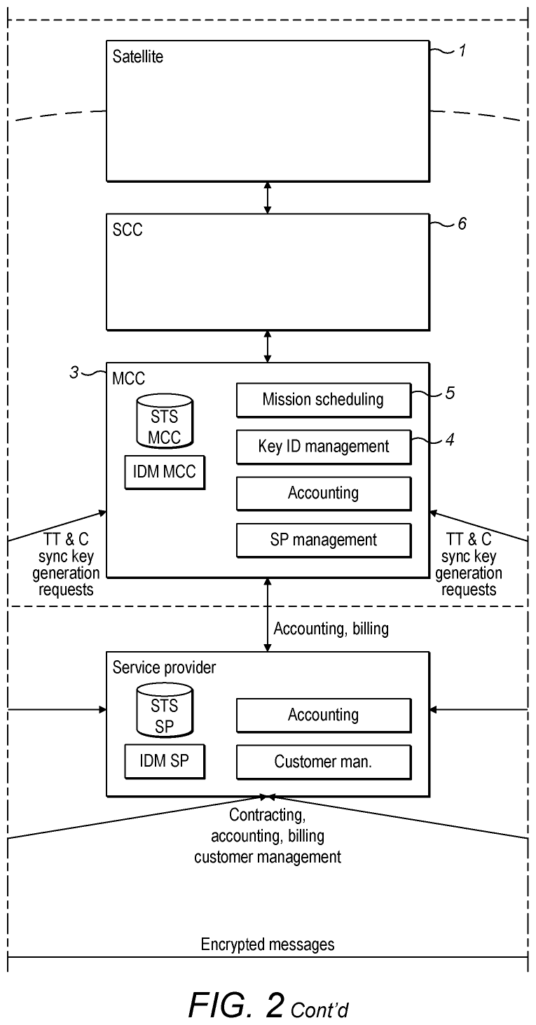

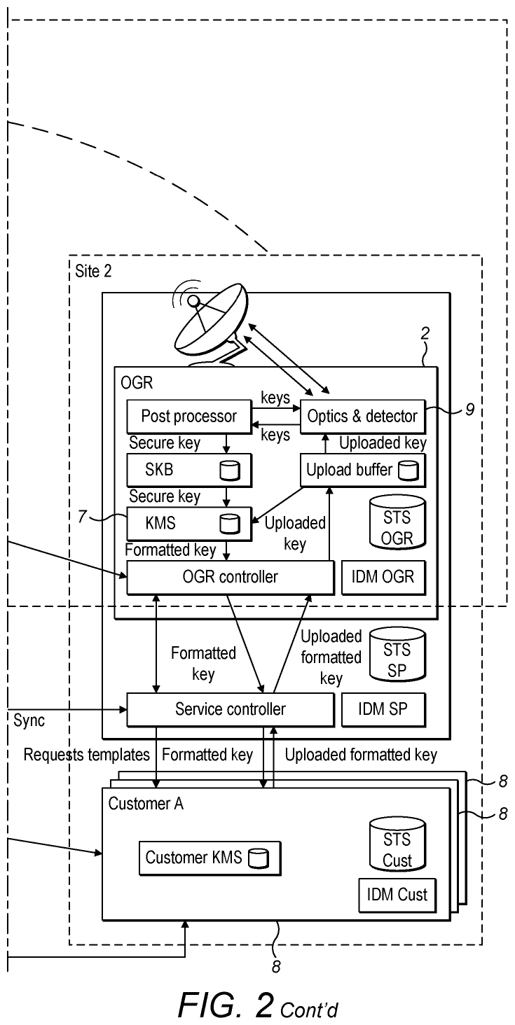

FIG. 1 is a schematic diagram illustrating an overview of an example of a satellite quantum key distribution system 100 according to a first embodiment of the invention, while FIG. 2 shows a more detailed system architecture of the satellite quantum key distribution system 100. The satellite quantum key distribution system 100 comprises a constellation of satellites 1 in earth orbit, a number of user ground stations 2, at least one ground control station 3, and a key management system 4. Communications between the at least one ground control station 3 and the constellation of satellites 1 may be provided by a satellite communications center 6. In the illustrated example the satellites 1 are in low earth orbit (LEO) inclined polar orbits. However, in other examples constellation may comprise satellites 1 in other orbits, for example geostationary orbit (GEO), or mid earth orbit (MEO). The constellation of satellites 1 may comprise one satellite 1, or may comprise multiple, i.e., two or more, satellites 1. In operation of the satellite quantum key distribution system 100 the satellites 1 use quantum key distribution (QKD) techniques to distribute encryption key data to the user ground stations 2. Each user ground station 2 then stores the encryption key data it has received in a key buffer 7 associated with the user ground station 2 for subsequent supply to users 8 for use in cryptographic services by the users 8 associated with the user ground station 2. In some examples, a user ground station 2 may be associated with, and provide encryption key to, only a single user 8. In other examples, a user ground station 2 may be associated with, and provide encryption key to, a plurality of users 8. Different ones of the user ground stations 2 of the system 100 may be associated with different numbers of users 8.

In order to support operation of the system 100 each satellite 1 may comprise a computer responsible for storing, securing and manipulating encryption key data and associated data. The computer may support security partitions within the satellite.

The key buffers 7 are data stores. Preferably, the key buffers 7 of the user ground stations 2 are data stores incorporated in hardware security modules (HSM). The HSM will ensure that any unauthorised attempts to extract keys are blocked or detected. The HSM provides tamper-detection sensors, such as wire cages surrounding encapsulated memory modules, detection of over- or under-voltages and temperatures, etc, The HSM will also provide restricted and authenticated communications interfaces to the cryptographic systems of end users 8 associated with the user ground stations 2.

The encryption key data provided to the user ground stations 2 by the constellation of satellites 1 are used to produce encryption keys to support cryptographic services between different users 8 associated with the user ground stations 2, such as encryption key based services. One example of such an encryption key based cryptographic service is encrypted communications, where the encryption keys may be used to encrypt transmissions over a conventional communication channel (e.g. a phone line, an internet connection, a radio frequency transmission, a fibre optic network, a private or proprietary secure network, such as a network using the Arqit secure communications methodology, etc.) between different users in order to maintain confidentiality of the communications. Other examples of encryption key based cryptographic services include other security related services such as confidentiality, data integrity, data/message origin authentication, entity identification, and non-repudiation. This list is not intended to be exhaustive. Other encryption key based services may be supported in some examples.

It will be understood that in order for cryptographic services between different users to be supported, the user ground stations 2 associated with the users participating in the cryptographic services must be provided with the same, common, encryption keys by the constellation of satellites 1, so that the user ground stations 2 can in turn provide the users participating in the cryptographic services with the same, common, encryption keys. Depending upon the details of the cryptographic services being supported this may require any number of users associated with different user ground stations 2 to be provided with the same common encryption keys, for example, two users, or three users, or more, and potentially a large number of users. The key management system 4 manages the supply of encryption key data from the constellation of satellites 1 to the different user ground stations 2 in order to ensure that the required encryption keys can be made available by the different ground user stations 2 to the users 8 associated with them.

In the illustrated embodiment the key management system 4 is located at one of the at least one ground control stations 3. This is not essential. However, the key management system 4 will need to be able to communicate securely with the at least one ground control stations 3, as will be explained below.

In the illustrated embodiment the at least one ground control station 3 comprises two ground control stations 3a and 3b. In other examples there may be a different number of ground control stations 3.

The, or each, satellite 1 has at least one optical transmitter and each user ground station 2 has at least one optical transceiver 9, which optical transmitters and transceivers 9 enable quantum optical communications links 30 to be established from the satellites 1 to the user ground stations 2. The, or each, satellite 1 also comprises at least one optical transceiver and each user ground station 2 has at least one optical transceiver 9, which enable classical (that is, non-quantum) optical communications links 31 to be established from between the user ground stations 2 and the satellites 1.

An overview of the operation of the satellite quantum key distribution system 100 is that the key management system 4 determines what encryption key data is required to be delivered to which user ground stations 2 by each of the satellites 1. The ground control station 3 generates schedules for encryption key delivery communication sessions between the satellites 1 and the user ground stations 2 based at least in part on this determination, and a respective schedule is transmitted to each of the satellites 1, and to selected user ground stations 2, by the ground control station 3 and stored on-board the satellites 1 for subsequent execution. The satellites 1 then proceed to carry out encryption key delivery sessions with the user ground stations 2 to distribute the encryption key data as they travel in their orbits, according to the respective schedules transmitted to the satellites 1 and user ground stations 2. The user ground stations 2 then use the encryption key data they have received to provide the encryption keys to their associated users, as required.

From the above summary it can be understood that key management across the entire satellite quantum key distribution system 100 is complex. The system 100, and in particular the key management system 4, needs to ensure that all user ground stations 2 associated with users requiring a common shared encryption key obtain exactly the same key data in a coordinated manner. All of the user ground stations 2 associated with users 8 requiring a common shared key for use in an encryption based service must obtain information as to when a shared common key is synchronised across all of the user ground stations 2 associated with the users 8 that require the shared common key before releasing the shared common key to the users 8 for use. This requirement can be understood as setting two objectives which must be achieved, that users requiring shared encryption keys must be provided with identical key data, and that users sharing keys must all be in possession of the key data at the time they wish to use the key.

Achieving these objectives is made more difficult by the characteristics of satellite key distribution, where for example, key distribution from a satellite 1 to a particular user ground station 2 may be impossible at some times, or may be disrupted part way through a key delivery session, for example due to cloud cover.

As is clear from the above, encryption key management in a satellite quantum key distribution environment is much more complex than in the classical encryption key environment, where two users mutually agree the content of an encryption key and the timing at which it is to be used between them using a common key exchange protocol such as Diffe Hellman.

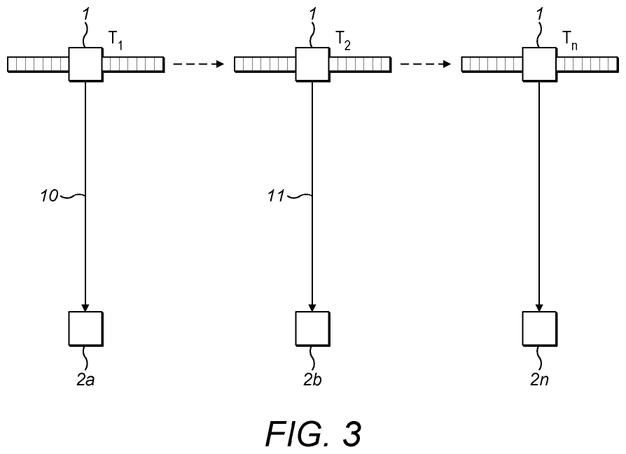

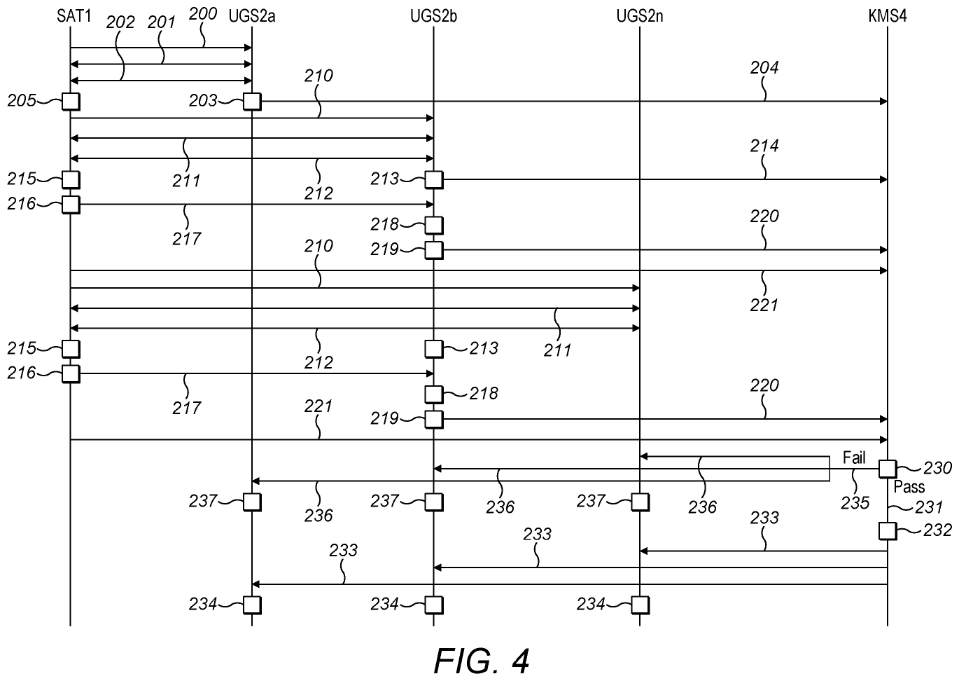

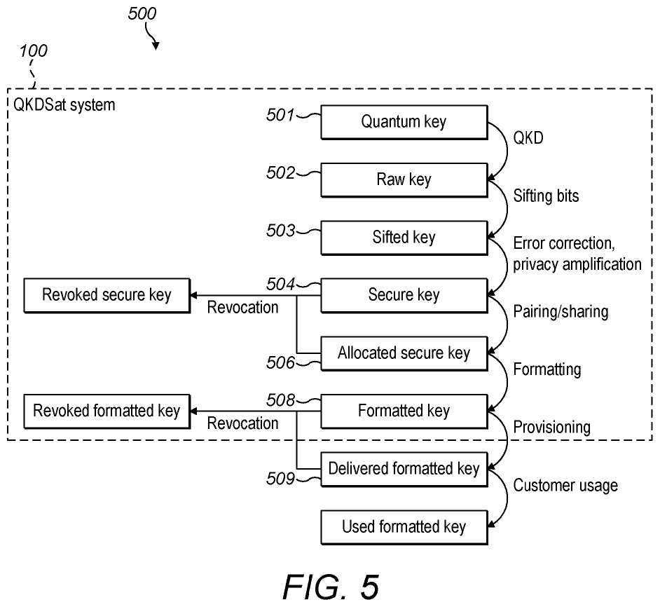

An example of a first QKD methodology which may be used in operation of the satellite quantum key distribution system 100 is shown in FIGS. 3 to 4. In the illustrated example of FIGS. 3 to 4, the satellite 1 is arranged to carry out quantum key distribution of common encryption keys to users associated with a group of ground user stations 2 comprising a plurality of user ground stations 2a to 2n. FIG. 3 shows a schematic diagram of the interactions between a satellite 1 and a plurality of user ground stations 2a to 2n, FIG. 4 shows a schematic diagram of the activities and messaging carried out within the system 100, and FIG. 5 shows an explanatory diagram of example of an encryption key lifecycle 500 which may be used in the system 100.

In the example of the first QKD methodology shown in FIGS. 3 to 5, in a first encryption key delivery communication session 200 between the satellite 1 and the first user ground station 2a at a time T1, a first string of random numbers is generated on the satellite 1 and used to encode data onto a stream of photons emitted by a single photon source on the satellite 1 that is directed in a beam to the first user ground station 2a to form a quantum optical communications link 10 from the satellite 1 to the first user ground station 2a. The stream of photons sent by the satellite 1 through the quantum optical communications link 10 is transmitted quantum key data 501. This is a series of quantum states of photons which may be used as a basis for the generation of encryption key bits, as explained below.

When the first encryption key delivery communication session 200 between the satellite 1 and the first user ground station 2a has been completed the data received by the first user ground station 2a is raw key data 502. This is based on the quantum key data 501 sent by the satellite 1, but may contain errors from the transmission and reception by the satellite 1 and the first user ground station 2a, introduced both through noise in the quantum channel and through differences in the transmission and reception measurement bases, such as differences between transmitted and measured polarity.

The satellite 1 and the first user ground station 2a then perform key sifting 201 of the transmitted quantum key data and the received raw key data by processing and exchanging information using a classical communication channel between the satellite 1 and the first user ground station 2a to publish the transmission and measurement bases utilised by the satellite 1 and ground station 2a, agree on a subset of bits of raw key data where the generating basis matches the measurement basis, and thereby sift out and delete bits of the raw key data where the transmitted polarisation differs from the measurement polarisation, to produce sifted key data 503 extracted from the photon stream.

The satellite 1 and the first user ground station 2a then perform error detection, error correction and privacy amplification 202 on the sifted key data by processing and exchanging information using a classical communication channel between the satellite 1 and the first user ground station 2a to correct errors introduced by the transmission process or by a potential eavesdropper and at the same time reduce an eavesdroppers knowledge of the key to an arbitrarily small amount at the cost of reducing the length of the key. The process results in the derivation of first secure key data 504, and then assigns a first one or more unique key handles to the first secure key data. A unique key handle is a name or identifier which can be used to uniquely reference a specific block of secure key data. Accordingly, the one or more key handles assigned to the first secure key data are associated with, and can be used to uniquely reference, the first secure key data. To maintain security, once the first secure key data has been derived the quantum key data, raw key data and sifted key data are deleted by the satellite 1 and the first user ground station 2. The number of key handles assigned to the first secure key data will depend upon the relative sizes of the blocks of secure key data to which the handles are assigned and the amount of the first key data which is delivered. The block of secure key data referenced by a key handle may have an arbitrary length.

The one or more unique key handles are assigned to a block of secure key data by the satellite 1 and communicated to the user ground station 2 using the classical communication channel between the satellite 1 and the user ground station 2. In alternative examples, the one or more unique key handles may be assigned by the user ground station 2.

The first ground user station 2a then stores 203 the received first secure key data together with the associated key handles and any associated metadata, in a key buffer 7 of the first user ground station 2a, and sends a report 204 of this, including the amount, i.e., the number of bits, of the first secure key data associated with each key handle to the key management system 4. The first secure key data, together with the associated key handles and any associated metadata, is also stored 205 in a key data store of the satellite 1. Optionally, the first secure key data may integrity checked by the key handles being reported by the satellite 1 to the key management system 4.

Subsequently, in a second encryption key delivery communication session 210 between the satellite 1 and the second user ground station 2b at a time T2 later than time T1, a second stream of random numbers is generated on the satellite 1 and used to encode data onto photons emitted by a single photon source on the satellite 1 that is directed in a beam to the second user ground station 2b to form a quantum optical communications link 11 from the satellite 1 to the second user ground station 2b. The stream of photons sent by the satellite 1 through the quantum optical communications link 10 is transmitted quantum key data 501.

When the second encryption key delivery communication session 210 between the satellite 1 and the second user ground station 2b has been completed the data received by the second ground user station is raw key data 502. This is based on the quantum key data 501 sent by the satellite 1, but may contain errors from the transmission and reception by the satellite 1 and the second user ground station 2b, introduced both through noise in the quantum channel and through differences in the transmission and reception measurement bases, such as differences between transmitted and measured polarity.

The satellite 1 and the second ground station 2b then perform key sifting 211 of the transmitted quantum key data and the received raw key data to agree sifted key data 503, and then perform error detection and error correction 212 on the sifted key data 503, by processing and exchanging information using a classical communication channel between the satellite 1 and the second ground station 2b to derive second secure key data 504 and assign a second one or more key handles to the second secure key data, in a similar manner to that explained above for the first encryption key delivery communication session 200. To maintain security, once the second secure key data has been derived the raw key data and sifted key data is deleted by the satellite 1 and the second user ground station 2b.

The second ground user station 2b then stores 213 the received second secure key data together with the associated one or more key handles and any associated metadata, in a key buffer 7 of the second user ground station 2b, and sends a report 214 of this, including the amount, i.e., the number of bits, of the second secure key data associated with each key handle to the key management system 4. The second secure key data, together with the associated one or more key handles and any associated metadata, is also stored 215 in a key data store of the satellite 1.

The satellite 1 then generates 216 an XOR of the first secure key data stored on the satellite 1 and the just delivered second secure key data and sends 217 this XOR from the satellite 1 to the second user ground station 2b using a classical (non-quantum) communications channel. The second ground user station 2b is then able to use the just received second secure key data and the received XOR data to derive 218 the first secure key data.

The amount, that is, the number of bits, of secure key data which can be transferred from the satellite 1 to a user ground station 2 by a specific encryption key delivery communication session may vary, and this variation may be due to both predictable and unpredictable factors. As a result, the amount of secure key data which can be transferred from the satellite 1 to a user ground station 2 by a specific encryption key delivery communication session cannot be accurately predicted in advance. Reasons for this variation may include known or predictable factors such as: the relative position and geometry of the orbit of the satellite 1 and the location of the user ground station 2, which may affect both the maximum length of a communications session and the quality of the quantum optical communications link, which may affect the bit rate at which the quantum key data can be delivered; the quality of the optical equipment at the specific user ground station, which may affect the bit rate at which the quantum key data can be delivered, local light pollution at the location of the specific user ground station, which may affect the bit rate at which the quantum key data can be delivered; and also may include unpredictable factors such as metrological conditions, for example cloud cover and haze, which may affect the bit rate at which the quantum key data can be delivered. This is not intended to be an exhaustive list, and other factors may also have an effect.

As a result, the size, that is, the number of bits, of the second secure key data delivered to the second user ground station 2b by the second encryption key delivery communication session 210 may be larger than, equal to, or smaller than, the size of the first secure key data delivered to the first user ground station 2a by the first encryption key delivery communication session 200. Accordingly, the second encryption key delivery communication session 210 may enable all of the first secure key data previously delivered to the first user ground station 2a by the first encryption key delivery communication session 200 to be delivered to the second user ground station 2b (if the number of bits of the second secure key data is larger than or equal to the number of bits of the first secure key data), or may only enable delivery of a part of this first secure key data to be delivered (if the number of bits of the second secure key data is smaller than the number of bits of the first secure key data).

The second ground user station 2b stores 219 the derived first secure key data which it has received, together with the associated key handles and any metadata, in a key buffer of the second user ground station 2b, and reports 220 this, the number of bits of the first secure key data associated with each key handle which have been received, and the number of bits of the second secure key data associated with each key handle which have been consumed by being used with the received XOR data to derive the first secure key data, to the key management system 4. Further, the satellite 1 reports 221 the number of bits of the first secure key data associated with each key handle which have been delivered to the second ground user station 2b to the key management system 4.

To maintain security, once some or all of the first secure key data has been derived the bits of the second secure key data used with the received XOR data to derive the first secure key data are deleted by the second user ground station 2b and the satellite 1. Conveniently, the bits of the second secure key data to be deleted by the second user ground station 2b may be overwritten with the derived first secure key data in the key buffer of the second user ground station 2b.

As discussed above, the size, that is, the number of bits, of the second secure key data delivered to the second user ground station 2b by the second encryption key delivery communication session 210 may be larger than, equal to, or smaller than, the size of the first secure key data delivered to the first user ground station 2a by the first encryption key delivery communication session 200. Accordingly, following the derivation 218 of the first secure key data and the deletion of the bits of the second secure key data used with the received XOR data to derive the first secure key data, the second user ground station 2b and the satellite 1 may still have a part of the second secure key data stored in their key buffers (if the number of bits of the second secure key data is larger than the number of bits of the first secure key data).

In this example, the satellite 1 is distributing common encryption keys to at least one further user ground station 2n. Accordingly, the copy of the first secure key data on the satellite 1 is retained on the satellite 1, and is not deleted, wholly or in part, in response to receipt of all, or part, of the first secure key data at the second user ground station 2b of the group.

If a part of the second secure key data has not been consumed to derive the first secure key data by the second user ground station 2b, copies of the part of the second secure key data which has not been consumed by the second user ground station 2b is retained in the key buffers of the satellite 1 and the second user ground station 2b for subsequent use. As will be discussed in more detail below this is unallocated key data. The retaining of such unallocated key data may improve the flexibility and efficiency of the system 100.

Subsequently, in examples where there are more than two user ground stations 2 in the group, further encryption key delivery communication sessions are carried out between the satellite 1 and further user ground stations 2 of the group. These further encryption key delivery communication sessions are substantially the same as the second encryption key delivery session 210 for the second user ground station 2b described above, so that actions 210 to 221 are repeated for each of the further user ground stations 2 in the group, up to and including the Nth user ground station 2n of the group.

It will be understood from the above that when the satellite 1 has successfully carried out at least one encryption key delivery communication session with each of the user ground stations 2a to 2n of the group, each of the second and subsequent user ground stations 2b-2n of the group will have received at least a part of the first secure key data.

As is explained above, the amount, that is, the number of bits, of secure key data which can be transferred from the satellite 1 to a user ground station 2 in a specific encryption key delivery communication session may vary, and this variation may be due to both predictable and unpredictable factors. As a result, each of the second to Nth user ground stations 2b-2n may have all of, or only a part of, the first secure key data stored in their respective key buffers. Further, the user ground stations 2b to 2n having only a part of the first secure key data stored in their respective key buffers may have different amounts of the first secure key data stored.

The part of the copy of the first secure key data on the satellite 1 corresponding to the part of the first secure key data which has been received by all of the second and subsequent user ground stations 2b-2n is no longer required, and is deleted from the key buffer of the satellite 1 for security reasons, and to free memory space on the satellite 1. This deletion may take place at any convenient time after the XOR to the Nth user ground station 2n has been generated. Thus, if all of the first secure key data has been received by all of the second and subsequent user ground stations 2b-2n, the copy of the first secure key data on the satellite 1 can be entirely deleted. Otherwise, the part of the copy of the first secure key data which has not yet been received by all of the second and subsequent user ground stations 2b-2n is retained in the key buffer of the satellite 1 for subsequent delivery to one or more of the second and subsequent user ground stations 2b-2n in a later encryption key delivery communication session.

As is explained above, the user ground stations 2a to 2n of the group send reports 204 and 220 to the key management system 4, and the satellite 1 sends reports 221 to the key management system 4. Accordingly, the key management system 4 is informed of the total size of the first secure key data stored at the first user ground station 2a, and how much of the first secure key data is stored at each of the other user ground stations 2b to 2n of the group.

When the satellite 1 has successfully carried out at least one encryption key delivery communication session with each of the user ground stations 2a to 2n of the group, so that each of the second and subsequent user ground stations 2b-2n of the group has received at least a part of the first secure key data, the key management system 4 carries out an integrity check 330 on the parts of the first secure key data reported to be stored at the different user ground stations 2a to 2n.

If the integrity check 230 is passed 231, confirming that all of the second and subsequent user ground stations 2b to 2n of the group have safely received at least a part of the first secure key data identified by the first one or more key handles, the key management system 4 determines the amount of the first secure key data common to all of the user ground stations 2a to 2n of the group, referred to as allocated secure key data 506, compares this amount to an encryption key format or formats previously requested by the group in a format comparison 232, and determines how this common first secure key data should be formatted into encryption keys. This may be done at any time after the satellite 1 has successfully carried out at least one encryption key delivery communication session with each of the user ground stations 2a to 2n of the group. It is not essential that this is carried out immediately. Conveniently, the common secure key data is formatted into keys in response to a user request for formatted encryption keys immediately before the requested formatted encryption keys are delivered. This may provide flexibility by allowing the common secure key data to be used to deliver formatted encryption keys based on user requirements at the time of delivery. In some examples, users may be informed how much common secure key data is available to the user ground stations 2a to 2n of the group to enable the users to make informed requests for formatted encryption keys.

When the first secure key data is to be formatted into encryption keys, the key management system 4 sends messages 233 to each of the user ground stations 2a to 2n instructing the user ground stations 2a to 2n to format the common first secure key data according to the determination, and in response the user ground stations 2a to 2n carry out the formatting in respective key formatting operations 234. The key formatting by the user ground stations 2a to 2n converts the common first secure key data into a number of formatted encryption keys 508 using one or more templates. Each of the user ground stations 2a to 2n formats the first secure key data according to a template describing features of the required formatted encryption keys. The features described by the template may include how long the encryption keys are to be (i.e., how many bits), what the encryption keys are to be used for, and how the encryption keys should be encoded. This is not intended to be an exhaustive list, and other features may be defined in the template. These formatted encryption keys are referred to as formatted keys herein. The formatted keys are stored in the respective key buffers 7 of the user ground stations 2a to 2n.

As is explained above, the amount of secure key data which can be transferred from the satellite 1 to a user ground station 2 in a specific encryption key delivery communication session may vary. As a result, there will often be some of the common first secure key data remaining at each of the user ground stations 2a to 2n after the key formatting has converted some of the common first secure key data into the formatted encryption keys. This remaining common first secure key data which has not be formatted into encryption keys is retained as first secure key data associated with its respective key handle in the key buffers of the user ground stations 2a to 2n for later use.

Alternatively, if the integrity check 230 is failed 235, so that the second and subsequent user ground stations 2b to 2n of the group have not all safely received at least a part of the first secure key data identified by the first key handle, the key management system 4 sends messages 236 to each of the user ground stations 2a to 2n instructing the user ground stations 2a to 2n to revoke a part or a whole of the common first secure key data, and in response the user ground stations 2a to 2n classify the common first secure key data as revoked secure key data in respective revocation operations 237. The revoked secure key data is not converted into formatted keys or otherwise processed by the system 100, or distributed to the users. The revoked secure key data may subsequently be deleted when convenient. Whether a part or the whole of the common first secure key data is revoked may depend upon the type of integrity check used and the nature of the failure. In some examples the common first secure key data is revoked on a per-block basis where blocks of first secure key data corresponding to specific key handles are used or revoked based on the results of the integrity check 230.

Details of the encryption key formats to be provided to each group of users, and where more than one encryption key format is to be used the relative numbers and priorities of the different encryption key formats, are instructed in advance by the users of the system 100 in cooperation with the key management system 100. These details are stored by the key management system 4, and the necessary encryption key templates to carry out the required formatting are provided to each of the group of user ground stations 2a to 2n by the key management system 4 and stored for later use. The templates define the features required by the user(s) to support desired encryption key based services between the user ground stations 2a to 2n. When users request encryption keys to be issued, the key management system 4 determines what common encryption keys should be produced from the available common first secure key data based on the amount of available common first secure key data, the secure key data requirements of the requested encryption key formats, and any priorities set by the user(s).

When the user or users associated with the group of user ground stations 2a to 2n request encryption keys, common formatted keys 509 are delivered to the user(s) from the respective key buffers of the group of user ground stations 2a to 2n. The delivered formatted keys 509 can then be deleted from the respective key buffers of the user ground stations 2a to 2n after a predefined period.

The user(s) associated with the user ground stations 2a to 2n can then use the common delivered formatted keys 509 to support encryption key based services between them.

If only a part of the first secure key data has been successfully received by one or more of the second and subsequent user ground stations 2b to 2n, further encryption key delivery communication sessions are carried out between the satellite 1 and those of the second and subsequent user ground stations 2b to 2n which have only received a part of the first secure key data until all of the first secure key data identified by the first key handle has been received by all of the second and subsequent user ground stations 2b to 2n.

One example of a suitable protocol which may be used to deliver the raw key data from the satellite 1 to each of the first and second user ground stations 2a and 2b in the first QKD methodology is the BB84 Decoy State protocol. In other examples different Prepare and Measure protocols, including for example other Decoy State protocols, may be used instead of the BB84 Decoy State protocol. Examples of a suitable single photon source which may be used by the satellite 1 in the first QKD methodology are a Weak Coherent Source or Faint Pulse Source.

The above example of the first QKD methodology uses XOR operations to securely transfer encryption keys between the satellite 1 and ground user stations 2. In other examples the XOR operations may be replaced by an alternative encryption scheme. Preferably such an alternative encryption scheme is of the One-Time-Pad (OTP) type. Suitable alternative encryption schemes may include the use of modulo arithmetic. An example of a modulo arithmetic encryption scheme is of the type encrypting number A and B by (A,B)=(A+B) modulo C, and decrypting by (A,B)=(A−B) modulo C, where in some examples C=256. Another example of a modulo arithmetic encryption scheme is of the type where encrypt (A,B)=decrypt(A,B)=(−A−B) modulo C, which is a self-inverse, similarly to XOR. Other forms of modulo arithmetic encryption scheme may also be used.

In the above example of the first QKD methodology the XOR operation used to transmit the first secure key data to the second and subsequent user ground stations 2b to 2n is carried out immediately after the respective secure key data has been delivered by an encryption key delivery communication session. This is not essential. The XOR operation may be carried out at any convenient time using a classical communications channel between the satellite 1 and the respective second and subsequent user ground station 2b or 2n, including being carried out on a separate later pass of the satellite 1 over the user ground station 2. In some examples this may be used to provide flexibility by building up a supply of secure key data stored at a user ground station 2 and a satellite 1, this store of shared secure key data can subsequently be used as necessary to support XOR operations to transfer secure key data from an other user ground stations 2 to the user ground station 2. This may, for example, enable secure key data from another user ground station 2 to be transferred from the satellite 1 to a user ground station 2 using the classic communications channel even when conditions make it impossible to establish quantum communications channel between the satellite 1 and the user ground station 1.

In the illustrated first example of FIGS. 2 and 3, the group of user ground stations 2a to 2n comprises at least three user ground stations 2a-2n. In other examples, there may be only two ground user ground stations, and in such examples the second user ground station 2b may be treated as the final user ground station 2n. In some examples a group may comprise a large number of user ground stations 2a to 2n.

The first example describes a system 100 where each user ground station 2 is providing encryption keys to a single user 8, for simplicity and ease of understanding. In other examples one, some, or all of the user ground stations 2 may provide encryption keys to more than one user 8. In such examples any user ground station 2 serving more than one user will need to receive secure key data as described above for each of the users 8 associated with it, and report and store the received secure key data for each of the users 8 associated with the user ground station 2 separately.

In operation of the satellite quantum key distribution system 100 there may be a large number of different groups of users associated with different user ground stations who require common encryption keys. A single user and their associated user ground station may be members of multiple groups simultaneously, and these multiple groups may have different members.

It will be understood that because the key data is delivered by the satellite 1 to different user ground stations 2 at different times, at any given time the secure key data is not necessarily synchronised across all of the user ground stations 2 intended and authorised to receive it. When using the first QKD methodology described above the secure key data cannot be immediately synchronised because of the timing limitations imposed by the need to provide common secure key data to all of the user ground stations 2 requiring it from the same satellite 1, so that it is necessary to wait for this satellite 1 to pass within communication range of all of the user ground stations 2 requiring the common secure key data as it progresses on its orbital path in order to deliver common key data to all of the user ground stations 2 requiring it and allow the secure key data to be synchronised. Even in systems 100 having a constellation comprising multiple satellites 1, when the QKD methodology described above is used it will be necessary for the common secure key data to be provided to all of the user ground stations 2 requiring it by the same single satellite 1.

Further, in practice, the delivery of specific key data to a particular user ground station to cannot be guaranteed to take place according to any specific timing or schedule. In addition to the predictable timing limitations discussed above, there are unavoidable uncertainties arising from unpredictable meteorological conditions, such as cloud cover, which may disrupt some or all of any given key delivery communication session between a satellite 1 and a user ground station 2. It will be understood that meteorological conditions may result in a planned or scheduled key delivery communication session not taking place at all, or may unpredictably reduce the amount of key data which can be delivered to a user ground station 2 by a satellite 1 in a key delivery communication session which does take place.

This gives rise to key management requirements for the satellite quantum key distribution system 100 which do not apply to conventional point-to-point encryption applications where two users can communicate directly to agree encryption keys to be used for cryptographic services between them.

As is explained above, secure key data is distributed initially to a user ground station 2 associated with one user 8, and at some indeterminate time(s) later to user ground station(s) 2 associated with other user(s) 8, so that there may be a significant period before the receipt of common secure key data at all of the user ground stations 2 associated with all of the users. Accordingly, the system 100 must ensure that formatted keys are only released from the user ground stations 2 to their associated users when the formatted keys are available at all of the user ground stations 2 associated with all of the users 8, which requires that the secure key data required to produce the formatted keys are delivered to all of the user ground stations 2 associated with all of the users 8. This avoids the problem of users 8 being issued with formatted keys that cannot be used and then having to determine when matching common keys have been delivered to the other users 8 so that the formatted keys can be used.

The key delivery process requires the “pairing” of the secure key data used to generate the formatted keys to provide paired secure key data 506. That is, the secure key data delivered to the different user ground stations 2 associated with the different users of a group requiring common encryption keys must match. In order to ensure this the system 100 requires knowledge of the characteristics of the secure key data delivered to a user ground station 2 associated with a first user, so that identical secure key data can be delivered, and identical formatted keys generated, at the user ground station(s) 2 associated with the other user(s) of a group.

In order for the pairing or grouping of the secure key data to be carried out it is necessary to “allocate” the required secure key data to the different user ground stations 2 and schedule encryption key delivery communication sessions among the different user ground stations 2 associated with the user(s) to deliver this required secure key data. This is necessary to ensure that formatted keys are available to the users for use between the different users that need them in the context of satellite key distribution, where key delivery cannot be guaranteed during any specific planned encryption key delivery communication session due to unfavorable meteorological conditions or the like, as discussed above. Accordingly, the system 100 must prioritize the allocation of secure key data for delivery between users having a relatively low amount of shared secure key data available for the production of formatted keys. For example, an amount of shared secure key data below, or close to, a predetermined threshold amount. The predetermined threshold amount may, for example, be set in a service level agreement (SLA) or other agreement between the user(s) and a system operator. In some examples the amount of shared secure key data may be expressed in terms of the number of formatted keys of a particular format which the shared secure key data could be used to produce for the user.

The quantum key distribution process and protocols require utilisation of a portion of the generated secure key data for entity and message authentication between the satellite and ground station, as well as other security management functions within the system including link encryption. Such secure key data used for internal system security purposes is buffered internally to the system and is not available for allocation or formatting for delivery to end users. This may be regarded as an overhead of generated secure key data required for the internal functioning of the quantum key distribution process itself.

To provide the functionality described above it is necessary for the key management system 4 to manage the various states of key data throughout the system 100 by maintaining a record of the location and status of the key data and controlling the operations of the system 100 based on this record.

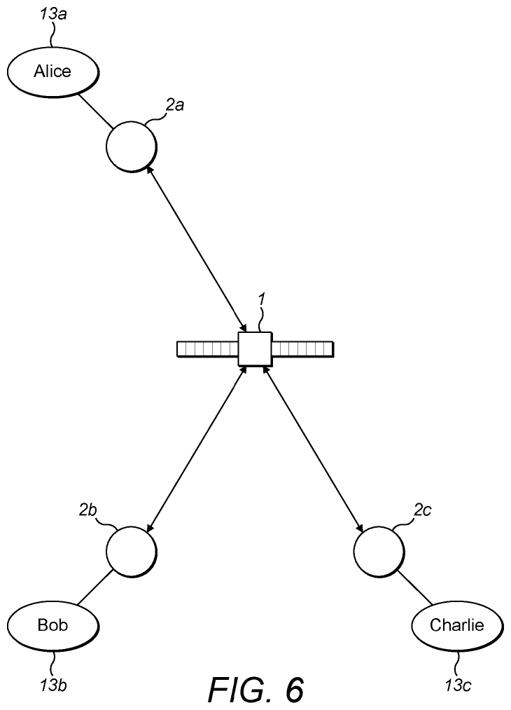

Some of the issues involved in the key management by the key management system 4 will be explained with reference to FIG. 6 by considering an example of a small group of three user ground stations 2 forming a small network. The network may comprise a central node Alice 13a that wishes to share encryption keys with two remote nodes Bob 13b and Charlie 13c to support encryption services between them across their network, as shown in FIG. 4. The system 100 can provide the desired shared encryption keys between the nodes Alice 13a, Bob 13b and Charlie 13c by a satellite 1 using the methodology of FIG. 3 to share encryption keys between first to third user ground stations 2a to 2c providing formatted encryption keys to the nodes Alice 13a, Bob 13b and Charlie 13c, respectively.

After the satellite 1 has overpassed and carried out a first encryption key delivery communication session 14a with the first user ground station 2a serving Alice 13a, the satellite 1 must know what secure key data has been received by the first user ground station 2a, and store this secure key data in on-board storage of the satellite 1. Further, the first user ground station 1a must know which secure key data it has successfully received. Further, the key management system 4 of the system 100 must know what secure key data the first user ground station 1a has received for Alice 13a, so that the key management system 4 can schedule the delivery of this secure key data to one or both of the second and third user ground stations 2b and 2c serving Bob 13b and Charlie 13c, as appropriate to the network requirements.

After the satellite 2 has overpassed and carried out a second encryption key delivery communication session 14b with the second user ground station 2b serving Bob 13b, the satellite 1 must know what secure key data has been received by the second user ground station 2b, so that this can be deleted from the on-board storage of the satellite 1 if it is not required to also be shared with Charlie 13c. Further, the second user ground station 1b must know which secure key data it has successfully received. Further, the key management system 4 must know what secure key data the second user ground station 1b has received for Bob 13b, so that the key management system 4 can inform the first and second user ground stations 2a and 2b which secure key data they now share which can be formatted to provide formatted encryption keys which can be released to Alice 13a and Bob 13b, and inform Alice 13a and Bob 13b that these formatted encryption keys are available for use between them.

After the satellite 2 has overpassed and carried out a third encryption key delivery communication session 14c with the third user ground station 2c serving Charlie 13c, the satellite 1 must know what secure key data has been received by the third user ground station 2c, so that this can be deleted from the on-board storage of the satellite 1, unless it is not required to also be shared with Bob 13b. Further, the third user ground station 1c must know which secure key data it has successfully received. Further, the key management system 4 must know what secure key data the third user ground station 1c has received for Charlie 13c, so that the key management system 4 can inform the first and third user ground stations 2a and 2c which secure key data they now share which can be formatted to provide formatted encryption keys which can be released to Alice 13a and Charlie 13c, and inform Alice 13a and Charlie 13c that these formatted encryption keys are available for use between them, and also inform the first to third user ground stations 2a to 2c which secure key data they now all share which can be formatted to provide formatted encryption keys which can be released to Alice 13a, Bob 13b and Charlie 13c, and inform Alice 13a, Bob 13b and Charlie 13c that these formatted encryption keys are available for use between them.

The key management system 4 operates in a manner which enables the necessary key management to be carried out, as will be explained below.

As can be understood from the description above of the first QKD methodology, secure key data stored at a user ground station 2 may have a number of different states. These different states include:
a) Secure key data stored at the user ground station with a copy stored on board a satellite, but not yet stored at any other user ground station. This secure key data is referred to as unpaired or unallocated key data herein. This secure key data is referred to as unpaired key data if it is required to be sent to one or more other ground user stations but has not yet been sent, and is referred to as unallocated key data if it has not yet been assigned to be sent to any other user ground stations. It will be understood that the difference between unpaired and unallocated key data is not a difference between the state of the secure key data, but is a difference between the currently intended future use of the secure key data.
b) Secure key data stored at the user ground station with a copy stored on board a satellite and required to be sent to one or more other user ground stations which has been delivered to and stored at at least one, but not all, of these other user ground stations. Such secure key data is referred to as partially paired key data. It should be understood that partially paired key data may be in a number of different “sub-states” defined by which combination of other user ground stations it has been delivered to. For example, if partially paired key data is required to be sent to three other user ground stations different parts of the partially paired key data may have been sent to different ones of, or combinations of, the other three user ground stations.
c) Secure key data stored at the user ground station and required to be sent to one or more other ground user stations which has been delivered to and stored at all of these other ground user stations. Such secure key data is referred to as paired key data. As discussed above, the copy of such paired key data held on a satellite is deleted from the satellite key buffer.

In order to enable the key management system 4 to carry out key management correctly across the system 100, the key management system 4 maintains a record of the secure key data stored at each user ground station 2, which record identifies the status of the different parts of the secure key data stored at that user ground station 2.

In order to allow the key management system to manage key data throughout the system 100 a unique identity is assigned to each element or block of the key data, this unique identity being the unique key handle. Each unique key handle is assigned to block of key data, the block of key data being a set of one or more bits of key data which share a status and can be addressed using a the unique handle as a unique identifier.

In order to facilitate key data management by the key management system 4, each block stored at each user ground station 2 is assigned a key handle and an associated set of metadata including at least:
a) A key handle. As discussed above, this is a unique identifier for a block, which is generated by the first user ground station 2 to receive the block as secure key data, and communicated to the satellite 1 which delivered the secure key data and the key management system 4.
b) A key type. This identifies the status of the block so that the key management system 4 can determine the type of the key data. Examples of a key type include: secure key data, paired secure key data, formatted key.
c) Target block size. This target number of bits of key data associated with this key handle. That is, the total size of the block.
d) Current block size. The actual number of received bits of key data of the block currently associated with this key handle at a specific user ground station 2.
e) User ground station pairing list. A list of all of the user ground stations with which the key must be paired. In some examples, for unallocated key data this will contain only the first user ground station 2 to receive the block.
f) Pairing status. The pairing status of the key data of the block for each user ground station listed in the user ground station pairing list, broken down to identify paired bits and unpaired bits for each of these user ground stations 2.

Optionally, in some examples, the metadata associated with a key handle may further comprise an integrity parameter, such as the results of a data integrity check. This may, for example be a checksum, or some other error check.

The key handle and associated metadata are stored together to provide a record of a block of key data.

As is explained above the key handles themselves are assigned to the blocks of secure key data by the satellite 1 and communicated to each user ground station 2 by the satellite 1. In other examples the key handles may be assigned by the user ground stations 2. In some examples the key handles may be given a format such as OGR-n [Key Handle 1, . . . Key Handle m]. Thus, for example an example for user ground station-23 may have the form OGR-23[1462, 1463, 1464]. The satellite will manage Blocks for each user ground station 2.

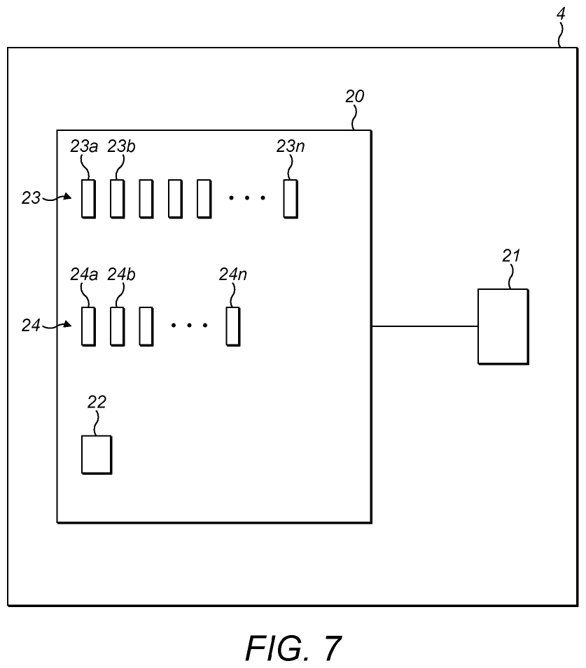

FIG. 7 shows a schematic diagram of a key management system 4 of the system 100.

As shown in FIG. 7, the key management system 4 comprises a data store 20 and a database controller 21. The data store 20 contains a user ground station status database 22. The user ground status database 22 contains a record for each user ground station 2 indicating the current status of that user ground station 2, the other user ground stations 2 with which that user ground station is grouped so that common encryption keys are required between those user ground stations, the key formats required to be used for these encryption keys, and details of agreements, such as work orders, for that user ground station 2 defining the target amount of paired key data which should be stored at that user ground station 2 ready to be issued to the user of the user ground station 2.

In examples where a user ground station 2 provides formatted encryption keys to multiple users the record for each user ground station 2 will include details of groupings, key formats and work orders or other agreements for all of the users.

The data store 20 further contains a set of user ground station data records 23a-n, each relating to a specific respective user ground station 2 of the system 100. Each user ground station data record 23 contains information identifying the amount of paired key data 506 stored at a specific user ground station 2, and which user ground station(s) 2 this paired key data is paired with. Such paired key data may include both secure key data available to be formatted into formatted encryption keys at each of a group of user ground stations 2 for issue to users requiring common encryption keys, and formatted keys at each of a group of user ground stations 2 available for issue to users requiring common encryption keys. Each user ground station data record 23 further contains information identifying the amount of partially paired key data stored at the specific user ground station 2, and which user ground station(s) 2 this partially paired key data is paired with and to be (but not yet) paired with. Each user ground station data record 23 further contains information identifying the amount of unallocated key data received by and stored at a specific user ground station 2, but not yet allocated to pairing to another user ground station(s) 2. The key data is recorded and identified in the user ground station records 23a-n using the unique key handles allocated to the different blocks of key data. As is explained above, the metadata associated with each key handle identifies the amount of bits of the data block associated with that key handle stored at a specific location, such as a specific user ground station.

Thus, a user ground station record 23a relates to a single user ground station 2a and contains the key handles and associated metadata of the secure key data blocks stored at the user ground station 2a. The metadata associated with each key handle will identify the status of the secure key data of the data block uniquely identified by that key handle.

For example, if the user ground station 2a is grouped with user ground station 2b for cryptographic services between users of the user ground stations 2a and 2b, and is also grouped with the user ground stations 2m and 2n for group cryptographic services between all of 2a, 2m and 2n, the user ground station record 23a will contain all of the key handles and associated metadata of data blocks stored wholly or in part at the user ground station 2a, and the metadata associated with each key handle will identify how much data of each block is stored at the user ground station 2a, and the pairing status of the stored data of each block.

Further, the data store 20 contains a set of satellite data records 24a-n each relating to a specific respective one of the satellites 1 of the constellation of satellites 1 of the system 100. Each satellite data record 24 contains information identifying the amount of partially paired key data stored at a specific satellite 1, and which user ground station(s) 2 this partially paired key data is paired with and to be (but not yet) paired with. Further, each satellite data record 24 further contains information identifying the amount of unallocated key data received from a user ground station 2 and stored at the satellite, but not yet allocated to pairing to another user ground station(s) 2. In some examples, the satellite data record 24 may include information regarding blocks of secure key data successfully delivered to all necessary user ground stations for pairing, for integrity checking purposes. However, the satellite 1 does not contain any paired key data because, as is explained above, this is deleted from the satellites

In operation of the system 100 the key management system 4 organizes key distribution and pairing across the system 100 and provides information regarding required encryption key delivery communication sessions to a scheduler of the at least one ground control stations 3 so that the scheduler can control the satellites 1 and user ground stations 2 to carry out the required encryption key delivery communication sessions.

It is important that the key distribution and pairing process (whereby keys are paired between user ground stations) is managed in a comprehensive manner rather than being undertaken in an ad-hoc way, where keys are distributed and paired on an opportunistic basis. This level of management is required to ensure that SLAs can be achieved across the network of user ground stations and users, for example, to ensure that users do not run out of encryption keys.

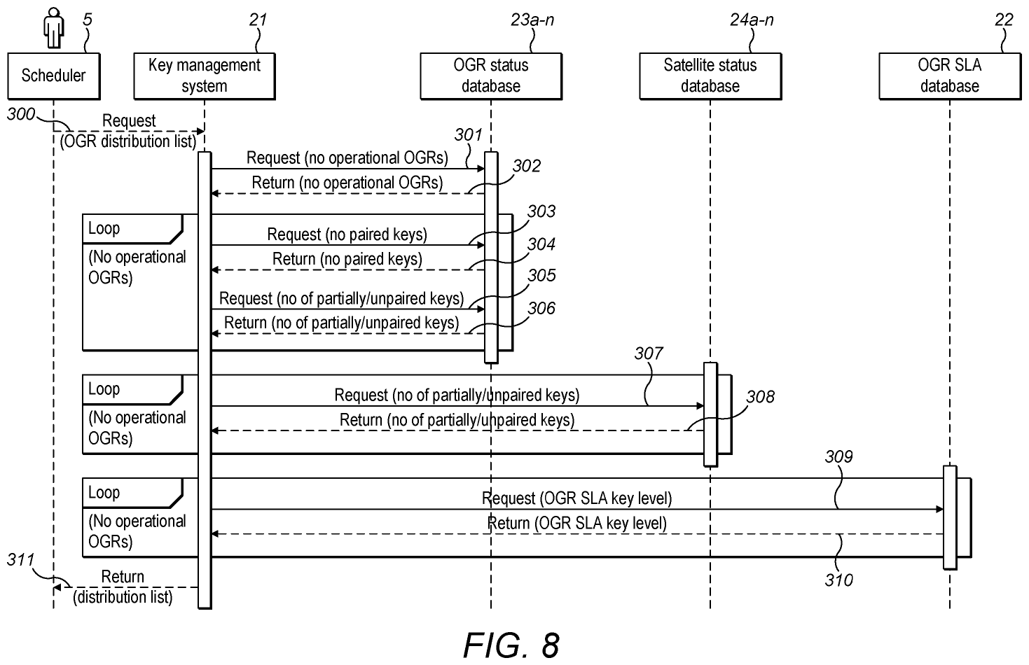

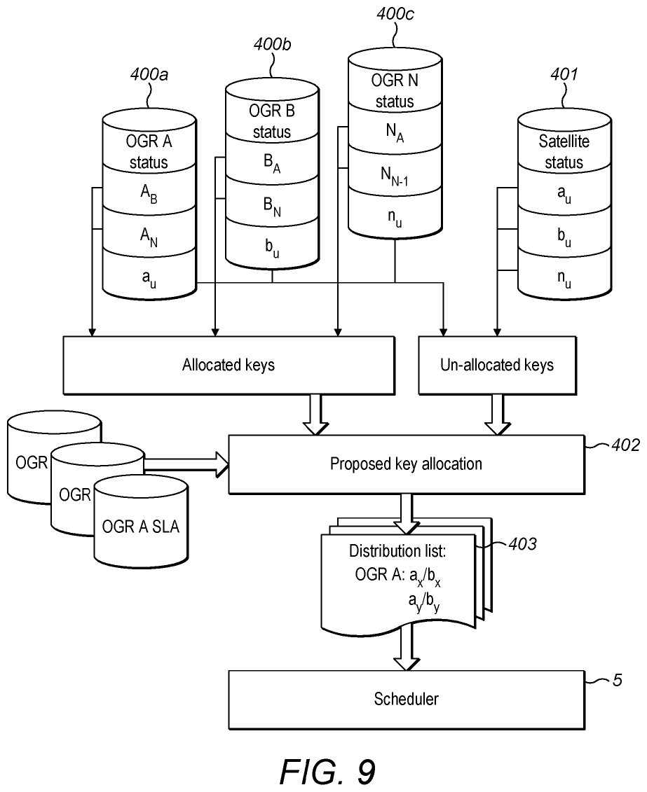

Some aspects of the key distribution and pairing process carried out by the key management system 4 is illustrated schematically in FIGS. 8 and 9.

In the illustrated example of FIG. 8, in a first step the scheduler 5 requests 300 the key management system 4 to generate a distribution list of required encryption key delivery communication sessions. In response to this request 300 the controller 21 of the key management system 4 requests 301 the user ground station records 23a to 23n to identify the operational user ground stations 2 in the system 100, and the user ground station records 23a to 23n return a reply 302 identifying the operational user ground stations 2. The query may, for example, identify the number of operational user ground stations 2 in the system 100. In some alternative examples the request 301 may be sent to, and the reply 302 received from, the user ground station status database 22. It will be understood that it is generally not necessary to take user ground stations 2 which are not operational into account.

In some examples, the request 300 from the scheduler 5 may identify user ground stations 2 which are available to carry out encryption key delivery communication sessions with satellites 1 during a predetermined future period of time. This may be determined, for example, by comparing ephemeris information for the satellites 1 with the location of the user ground stations 2. This may be useful in order to avoid the key management system 4 and scheduler 5 wasting system resources considering user ground stations 2 which cannot currently carry out encryption key delivery communication sessions.

Then, for each of the identified operational user ground stations 2, the controller 21 requests 303 from the respective user ground station record 23 an amount of paired key data at that user ground station 2, and the user ground station record 23 returns a reply 304 providing the amount of paired key data at that user ground station 2. Further, for each of the identified operational user ground stations 2, the controller 21 requests 305 from the respective user ground station record 23 an amount of partially paired and unpaired key data at that user ground station 2, and the user ground station record 23 returns a reply 306 providing the amount of partially paired and unpaired key data at that user ground station 2. The information for the replies 304 and 306 can be readily determined from the current block size information and pairing status associated with the key handles stored in the user ground station record 23 for each user ground station 2.

The requests and replies 303 to 306 are repeated for each respective operational user ground station 2 until all of the operational user ground stations 2 have been processed.

The controller 21 analyses the replies 304 and 306 for the different operational user ground stations and determines, for each user ground station 2, a user ground station data status identifying the volume of key data at that user ground station 2 which has been paired with other grouped user ground stations 2, so that it is available for distribution to users of the grouped user ground stations 2 as formatted encryption keys.

FIG. 9 shows schematically an example for a system 100 comprising operational user ground stations 2a and 2b to 2n and a single satellite 1. In this example the controller 21 generates a respective user ground station data status 400a and 400b to 400n for each of the operational user ground stations 2a and 2b to 2n. In the illustrated example of FIG. 7 each of the user ground stations 2a and 2b to 2n is grouped with each of the other user ground stations 2a and 2b to 2n to allow end-to-end cryptographic services between each pair of user ground stations 2a and 2b to 2n.

Accordingly, the user ground station data record 400a contains a record AB of the amount of paired key information stored at the user ground station 2a and also paired with, and so at stored at, the user ground station 2b. Further, the user ground station data record 400a contains a record AN of the amount of paired key information stored at the user ground station 2a and also paired with, and so stored at, the user ground station 2n. Further, the user ground station data record 400a contains a record aᵤ of the amount of unallocated key information stored at the user ground station 2a. Similarly, the user ground station data record 400b contains a record B_{A} of the amount of paired key information stored at the user ground station 2b and paired with the user ground station 2a, a record B_{N} of the amount of paired key information stored at the user ground station 2b and paired with the user ground station 2n, and a record bᵤ of the amount of unallocated key information stored at the user ground station 2b. The remaining user ground data station records 400 have corresponding information for their respective user ground stations 2.

It will be understood from the above that if the system 100 is operating correctly the amount of paired key information stored at grouped user ground stations 2 should correspond. Thus, in the example of FIG. 9, the amount of paired data AB and the amount of paired data B_{A} should correspond. Accordingly, when the user ground station data records 400 have been generated the controller 21 carries out an integrity check by checking whether the amounts of paired key data stored at the different user ground stations 2 match. If these amounts match the paired key data is regarded as passing the integrity check. Any paired key data which does not match is regarded as failing the integrity check, and may be discarded.

Then, for each of the identified operational user ground stations 2, the controller 21 requests 307 from the satellite data records 24 an amount of partially paired and unpaired key data for that user ground station 2 which is stored on a satellite 1 of the constellation of satellites 1, and the satellite data records 24 return a reply 308 providing the amount of partially paired and unaired key data for that user ground station 2. The information for the replies 308 can be readily determined from the current block size information and pairing status associated with the key handles stored in the satellite records 24.

The controller 21 analyses the replies 308 from the different operational user ground stations and determines, for each satellite 1, a satellite data status 401 identifying the volume of key data at that satellite 1 which is associated with a user ground station 2, but is unallocated.

In the example of FIG. 9 the controller 21 generates a satellite data status 401 for the satellite 1. The satellite data record 401 contains a record aᵤ of the amount of unallocated key information stored at the satellite 1 for user ground station 2a, a record bᵤ of the amount of unallocated key information stored at the satellite 1 for user ground station 2b, and a record nu of the amount of unallocated key information stored at the satellite 1 for user ground station 2n.

It will be understood from the above that if the system 100 is operating correctly the amount of unallocated key information stored at the user ground stations 2 and on the satellites 1 should correspond. Thus, in the example of FIG. 9, the amount of unallocated data au recorded in the user ground station data record 400a and the satellite data status 401 should correspond. Accordingly, when the user ground station data records 400 and the satellite data status 401 have been generated the controller 21 carries out an integrity check by checking whether the amounts of unallocated key data stored at the different user ground stations 2 and the satellite 1 match. If these amounts match the unallocated key data is regarded as passing the integrity check. Any unallocated key data which does not match is regarded as failing the integrity check, and may be discarded. This unallocated key data integrity check is not essential, and may not be carried out in some examples.

In the example of FIG. 9 only the records relating to the user ground stations 2a, 2b and 2n are shown for clarity. It will be understood that similar records relating to the other user ground stations 2 will exist in practice.

Then, for each of the identified operational user ground stations 2, the controller 21 requests 309 from the user ground station status database 22 information regarding the agreed work order or other agreement for that user ground station 2, and the user ground station status database 22 returns a reply 310 providing the requested information regarding the agreed work order or other agreement for that user ground station 2.

The controller 21 then compares 402 the identified paired and unallocated key data at each user ground station 2 and compares this paired and unallocated key data with the work orders for the user ground stations 2 which specify the amount of key data required at each user ground station 2 which is paired with each other user ground station 2 to provide encryption keys to a user or users. The controller 21 uses this information to derive a proposed key pairing, at a block level. From this bit level pairing the controller 21 generates a block level key allocation which, for each specific user ground station 2, proposes allocating a set of one or more blocks of key data (that is, key data associated with particular key handles and shared status) with one grouped user ground station 2, and another set of one or more blocks with another grouped user ground station 2, according to priorities derived from the work orders. As explained above, the key pairing is carried out at block level, that is, block by block. It should be remembered that the block size is generally variable, so that these block can be of any desired size, including down to bit level if necessary.

One specific priority which may be used by the controller 21 to generate the block level key allocation is a comparison of the amount of paired key data stored at each specific user ground station 2 to the target amount of paired key data which should be stored at that user ground station according to the work order for that user ground station 2.

The controller 21 uses the block level allocations to generate a set of distribution lists 403, where each distribution list 403 relates to a specific user ground station 2 and sets out the proposed block level key allocation for that user ground station 2. The controller then sends 311 the distribution lists 403 to the scheduler 5.

The scheduler 5 then uses the distribution lists to generate schedules for encryption key delivery communication sessions between the satellites 1 and user ground stations 2, and sends these schedules to the satellites 1 and user ground stations 2 for execution.

In some examples the schedules may contain separate entries for encryption key delivery communication sessions between the satellites 1 and user ground stations 2 which deliver secure key data using a quantum communication channel and activities relating to pairing and allocation of key data, such as the transfer of secure key data using an XOR process, which can be carried out over a classical communication channel only, provided that there is sufficient unallocated secure key data available at each user ground station 2 of interest.

As discussed above, in some examples, the request 300 from the scheduler 5 may identify user ground stations 2 which are available to carry out encryption key delivery communication sessions with satellites 1 during a predetermined future period of time, so that the distribution lists and schedules do not include encryption key delivery communication sessions which cannot currently be carried out.

In some examples it may only be possible to send an updated schedule to a satellite 1 periodically when the satellite 1 passes over one of the at least one ground control stations 3. In such examples the controller may generate a set of distribution lists 403 and send these to the scheduler 5 at a suitable time to send a new schedule to the satellite 1.

One issue which may arise in the embodiment described above is that it may only be possible for a satellite 1 to send key status information to the key management system 4 periodically when the satellite 1 passes over one of the at least one ground control stations 3. In such examples, it will be necessary to wait for the key status information from the satellite 1 before reports from the user ground stations 2 regarding key distribution sessions, which may be immediately sent to the key management system 4, can be processed, so that it may be necessary to delay such processing until the corresponding key status information is received from the satellite 1. In some examples this delay may be avoided by arranging for the satellite to send the key status information to a user ground station 2 at the end of their communication session, for example by using a classical optical communications channel, and arranging for the user ground station 2 to relay the key status information from the satellite 1 to the key management system 4.

In the example of FIG. 9 the controller 21 generates a respective user ground station data status 400a and 400b to 400n for each of the operational user ground stations 2a and 2b to 2n, in which each user ground station data status 400 identifies the volume of key data at a specific user ground station 2 which has been paired with other grouped user ground stations 2. In other examples each user ground station data status 400 generated by the controller 21 may further identify the volume of partially paired key data, that is, key data that needs to be paired among a plurality of other user ground stations 2 but has only been paired for a subset of these plurality of other user ground stations 2. The volume of partially paired key data may be determined for different subsets of other user ground stations 2, and this volume may be compared for different ones of the subsets of paired user ground stations 2 as a further integrity check.

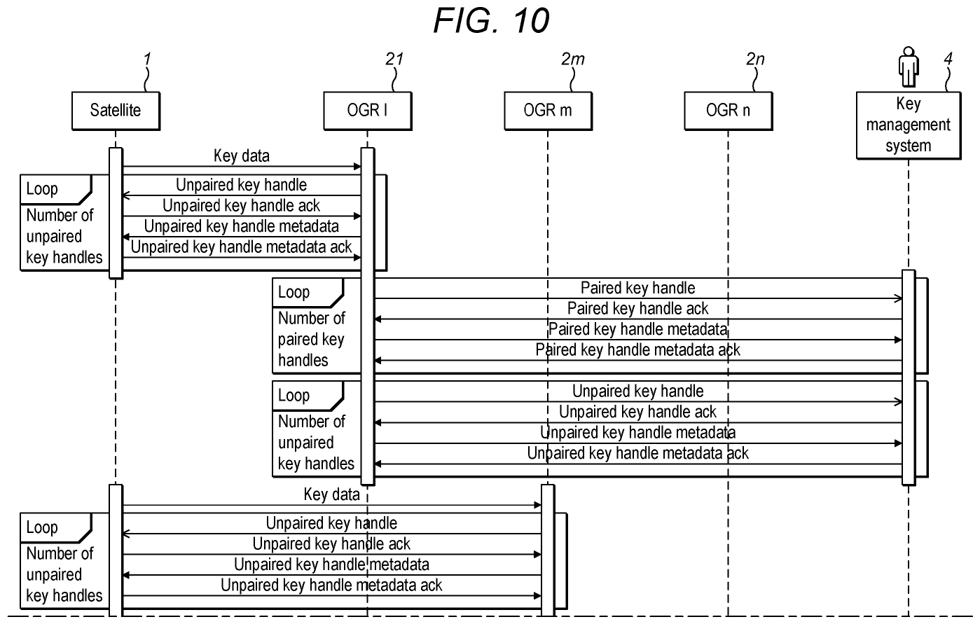

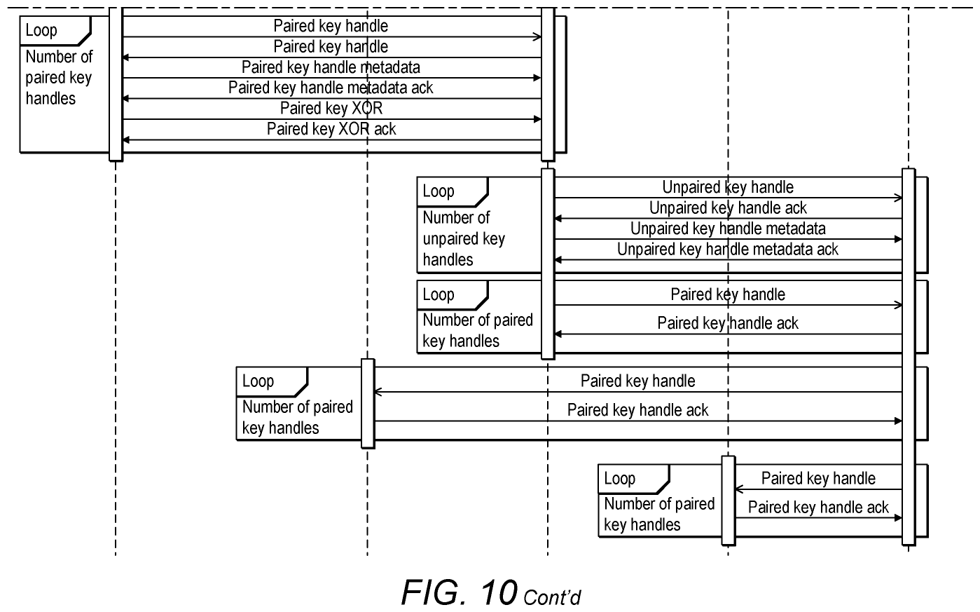

A worked example of the key management process set out above will now be described with reference to FIG. 10. FIG. 10 shows a schematic diagram of communications between a satellite 1, a plurality of user ground stations 2, and the key management system 4.

In the worked example, there is a user specified request to share 2×130 bit formatted keys between a user ground station 21 in London and a user ground station 2m in Chicago, and 1×152 bit formatted key between London and a user ground station 2n in Hong Kong. That user specified request will be derived from the end user's requirements as captured in their SLA, combined with real time status information regarding the status of the London, Hong Kong and Chicago user ground station key buffers. This request is sent to the scheduling system 5 of the ground control station 3 and QKD quantum key delivery sessions are scheduled for overpasses of London, Chicago and Hong Kong by a satellite 1.

In this example the satellite 1 is flying over London first and the link is expected to be good, so the key management system 4 schedules (260+152)=412 bits to send to the London user ground station 21. The satellite 1 actually succeeds in sending 500 bits which go into a secure key block within the London user ground station 21. These bits will be stored in appropriate size blocks and a report of this is sent to both the satellite 1 and the key management system 4 as key handles in the form:

OGR-London [KH1LON, KH2LON, KH3LON, KH4LON].

The Metadata is also reported to the key management system 4 and a subset is sent to the satellite 1 for all blocks which are partially paired or unpaired: In this example, the key management system 4 will receive, for the different key handles:

Key Handle—KH1LON
Key Type—Secure Key
Target Block Size—130 bits
Current Block Size—130 bits
OGRS Pairing List—OGR London, OGR Chicago
Pairing Status—paired 0, unpaired 130

Key Handle—KH2LON
Key Type—Secure Key
Target Block Size—130 bits
Current Block Size—130 bits
OGRS Pairing List—OGR London, OGR Chicago
Pairing Status—paired 0, unpaired 130

Key Handle—KH3LON
Key Type—Secure Key
Target Block Size—152 bits
Current Block Size—152 bits
OGRS Pairing List—OGR London, OGR Hong Kong
Pairing Status—paired 0, unpaired 152

Key Handle—KH4LON
Key Type—Secure Key
Target Block Size—undefined
Current Block Size—88 bits
OGRS Pairing List—OGR London, undefined
Pairing Status—paired 0, unpaired 88

In the key handle examples herein the user ground stations 2 are referred to by the abbreviation “OGR”.

The satellite 1 will receive from the London user ground station 21 all of the Key Handles and the number of unpaired bits for each which must be stored in the “London block” on-board the satellite 1, in the satellite key buffer.

The satellite then flies over Chicago and is scheduled by the key management system 4 to deliver 260 bits but only succeeds in sending 102 secure bits. Hence it takes 102 bits from the on-board London block sequentially for key handle KH1, XORs them with the Chicago bits and sends them to the Chicago user ground station 1. It includes the ID of the Key Handle KH1 in the message. The Chicago user ground station 1 then contacts the key management system 4 to report that it has received the 102 bits for key handle KH1. These bits are now paired across London and Chicago. The satellite 1 can also scrub those bits from its key buffer memory. In this example, the key management system 4 will receive, for the key handle KH1:
Key Handle—KH1CHI
   Key Type—Secure Key
   Target Block Size—130 bits
   Current Block Size—102 bits
   OGRS Pairing List—OGR London, OGR Chicago
   Pairing Status—unpaired 0, paired 102

Next the satellite 1 flies over Hong Kong and is tasked with sending bits for KH3. It succeeds in sending 160 bits to the Hong Kong user ground station 2n, and so the satellite 1 takes 152 bits from the London KH3 block, XORs them with the 152 of the Hong Kong bits, and sends to the Hong Kong user ground station 2m. The Hong Kong user ground station 2m then contacts the key management system 4 over a ground link to report that it now has 152 bits for key handle KH3. The satellite 1 scrubs those bits from its key buffer memory. The Hong Kong user ground station 2m and the satellite 1 can also put the extra 8 bits into a new Hong Kong block (KH5) for later use when needed. In this example, the key management system 4 will receive, for the key handles KH3 and KH5:
Key Handle—KH3HKN
   Key Type—Secure Key
   Target Block Size—152 bits
   Current Block Size—152 bits
   OGRS Pairing List—OGR London, OGR Hong Kong
   Pairing Status—paired 152, unpaired 0
Key Handle—KH5HKN
   Key Type—Secure Key
   Target Block Size—undefined bits
   Current Block Size—8 bits
   OGRS Pairing List—OGR Hong Kong, undefined
   Pairing Status—paired 0, unpaired 8

Finally, the satellite 1 flies over Chicago again and succeeds in sending 58 bits to the Chicago user ground station 2m. It takes the remaining 28 bits from the KH1 block, XORs them with the Chicago bits and sends them to Chicago user ground station 2m, including the key handle in the message. This is repeated with the remaining 36 bits, which are XORed with the next 30 bits from the London KH2 block. The Chicago user ground station 2m then contacts the key management system over a ground link to report reception of the final 28 bits for KH1 and the first 30 bits for KH2. The satellite 1 can also scrub those bits from its key buffer memory. In this example, the key management system 4 will receive, for the key handles KH1 and KH2:
Key Handle—KH1CHI
   Key Type—Secure Key
   Target Block Size—130 bits
   Current Block Size—130 bits
   OGRS Pairing List—OGR London, OGR Chicago
   Pairing Status—unpaired 0, paired 130
Key Handle—KH2CHI
   Key Type—Secure Key
   Target Block Size—130 bits
   Current Block Size—30 bits
   OGRS Pairing List—OGR London, OGR Chicago
   Pairing Status—paired 30, unpaired 100

At this point in the key management process the status of the requested key data at the three user ground stations 2l, 2m and 2n in London, Chicago and Hong Kong is as follows:

TABLE 1

| Key | | Hong | Paired | Unpaired | Available for |
|---|---|---|---|---|---|
| Handle | Chicago | Kong | Bits | Bits | End User |
| KH1 | LON | CHI | 130 | 0 | Yes |
| KH2 | LON | CHI | 30 | 100 | No |
| KH3 | LON | HNK | 152 | 0 | Yes |
| KH4 | LON | Unassigned | 0 | 88 | No |
| KH5 | HNK | Unassigned | 0 | 8 | No |

It should be noted that only the status of the requested key data in the Chicago and Hong Kong user ground stations 2m and 2n is indicated in table 1. All of the data for key handles KH1 to KH5 is of course present at the London user ground station 21 where it originated.

After this point the key management process can now continue with the key management system scheduling the satellite 1 to deliver a further 100 bits to the Chicago user ground station 2n to complete the block with Key Handle KH2, etc.

As can be understood from the above worked example the satellite 1 only needs to buffer at maximum the “in flight” number of bits, and every successful transmission reduces that number. The user ground stations 2 will need to hold the full number of bits required until completely successfully transmitted. The bit addresses for each block can be local to each user ground station 2, there is no need to allocate the bit addresses globally, so there can be blocks in the different user ground stations 2, in the example the user ground stations 2 in London, Chicago and Hong Kong with different addresses.

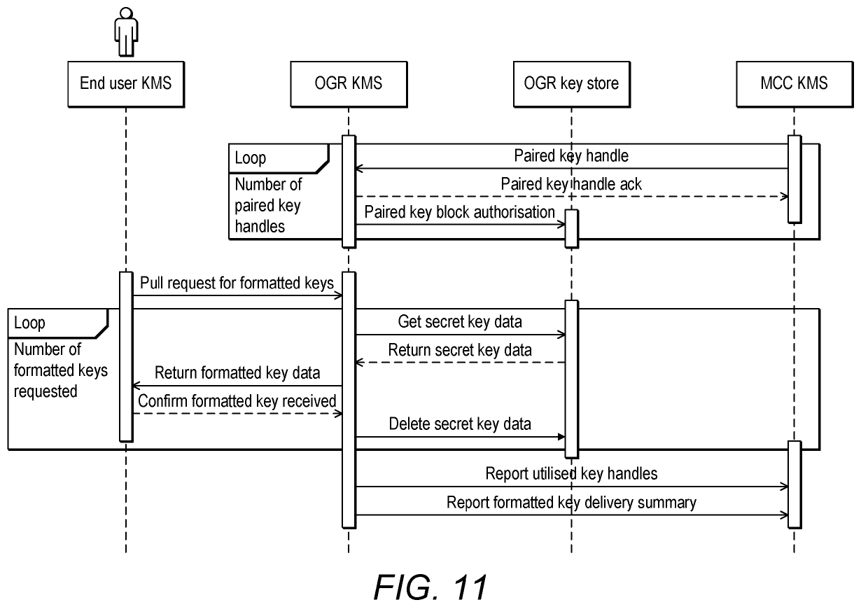

The embodiments set out above describe how paired secure key data and/or formatted keys are distributed to grouped user ground stations 2 to the system 100. After this, a final stage of the distribution process is the delivery of formatted keys to end user Key Management Systems of the users. An example of this final stage is shown in FIG. 11.

In order to enable the delivery of formatted keys to end user key management systems, a key management system (KMS) of a user ground station 2 must be informed by the key management system 4 of all the Key Handles which have been paired with the necessary grouped user ground stations 2 so that it can deliver them to the end user in a synchronised way. Effectively, the key management system 4 reports the paired Key Handles to the KMS of the user ground station 2 which then authorises their removal from the user ground station 2 key store for distribution to end users at their request.

When an end user wishes to obtain formatted keys, it requests a number of formatted keys. These must be created by a respective user ground station 2 from the paired secret key data 506 at the user ground station 2 which has been authorised for distribution. These keys are created according to a format provided by the end user during service commissioning, as discussed above.

When using the system 100 and method described above, for efficient use of the quantum link, each user ground station 2 can maintain a block of successfully transmitted partially- or unpaired secure key bits, with a copy held in the satellite 1, which key bits have not yet been allocated to another user ground station 2. The size of each block would depend on demand statistics and on predicted success rates for each satellite to OGR link. This would mean that no quantum bits are wasted, as any surplus is simply processed and stored until required later. When a constellation of multiple satellites 1 are deployed, each user ground station 2 will need a block of secure bits stored on each satellite 1.

The unshared secure key Blocks may be of totally arbitrary length, so that there is no requirement to fix a minimum block size greater than 1 bit, which potentially wastes odd bits that don't fit into a block. The approach described above is valid with arbitrary Block sizes.

The approach described above allows the transmission of quantum bits from a satellite 1 to a user ground station 1 to be separated from the matching and XORing (or other alternative encryption scheme) in the satellite 1 used to transmit key data stored on the satellite 1 to the user ground stations 2. This separation is achieved by use of the block process. This allows the transmission schedule to be arranged efficiently, with longer transmissions possible (if cloud cover permits) than is immediately needed, building up a stock of unallocated key data for a user ground station 2 on the satellite 1. The matching process consuming this stock of unallocated key data on the satellite 1 is then only required as secure bits are allocated for matching between the user ground station 2 and other user ground station(s) 2.

This can be advantageous for servicing user ground stations 2 at locations where it is generally difficult (statistically speaking) to carry out an encryption key delivery communication sessions between a satellite 1 and the user ground station 2. An example of such a location would be Bogota where it is statistically rare for the meteorological conditions to be clear enough for communication sessions to be carried out. Another example, when the technology used to establish a quantum optical communications link requires the satellite to be in eclipse, would be northern Canada (or other near-polar areas) where there may be several months without a dark night during which a QKD communications session can be performed.

In such locations where it is difficult to carry out an encryption key delivery communication session the system 100 may be arranged to take advantage of the (statistically rare or widely separated in time) occasions when such communication sessions are possible to build up a large stock of unallocated key data at the user ground station 2 and on the satellite 1, By buffering up key data in advance in this way good service levels of key provision can be maintained to users in these areas, and to users who require common encryption keys with such users. As is explained above, the transmission of secure key data from a satellite 1 to a user ground station 2 by a XOR process using a classical communications channel may be carried out at any time. Accordingly, such unallocated key data may be used allow transmission of secure key data from a satellite 1 to a user ground station 2 using a classical communications channel at times when an encryption key delivery communication session using a quantum communication channel is not possible.

The block of secure key data bits for each user ground station 2 can be allocated on a first-in/first-out (FIFO) basis. This allows the key management system 4 to keep track of each user ground station secure key data block at a Block level using the Key Handles.

As discussed above, the controller 21 may generate the block level key allocation based at least in part on a comparison of the amount of paired key data stored at each specific user ground station 2 to a target amount of paired key data which should be stored at that user ground station according to the SLA for that user ground station 2. In some examples, user ground stations 2 at locations where it is generally difficult (statistically speaking) to carry out an encryption key delivery communication sessions between a satellite 1 and the user ground station 2 may be assigned larger target amounts of paired key data in order to allow for (statistically likely) difficulties in delivering secure key data. In some examples, user ground stations 2 at locations where it is generally difficult (statistically speaking) to carry out an encryption key delivery communication sessions between a satellite 1 and the user ground station 2 may be provided with larger key buffers (that is, key buffers with greater capacity), again in order to allow for (statistically likely) difficulties in delivering secure key data.

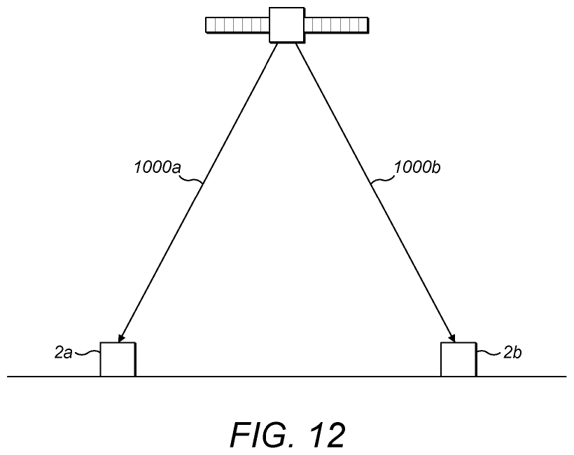

An example of a second QKD methodology which may be used in operation of the satellite quantum key distribution system 100 is shown in FIG. 12. In the example of FIG. 12 the satellite 1 is arranged to carry out quantum key distribution of an encryption key to a first user ground station 2a and an associated second user ground station 2b simultaneously. In the methodology shown in FIG. 2, a pair of photons are generated on the satellite 1 which share entangled quantum properties, such as polarisation. The photons being part of entangled pairs are transmitted to the user ground stations, with one photon from each pair being transmitted in a beam 1000a to the first user ground station 2a and the other photon from each pair being transmitted in a beam 1000b to the second user ground station 2b. Once received, the first and second user ground stations 2a and 2b detect the quantum information and use this, through a key agreement process, to determine the key, which the first and second user ground stations 2a and 2b then store in respective key buffers. The stored encryption key can then be used by the first and second user ground stations 2a and 2b to support cryptographic services. The key agreement process used by the first and second user ground stations 2a and 2b may include the use of key sifting carried out between the first and second user ground stations 2a and 2b over a conventional communications channel 4 to agree what key data to use. Accordingly, the associated first and second user ground stations 2a and 2b are provided with common encryption keys to support cryptographic services between, or involving, the associated first and second user ground stations 2a and 2b. In this case key handles and key metadata for the common encryption keys are generated in the exchange between the ground station and other ground station and reported to the Key Management System. One example of a suitable protocol which may be used between the satellite 1 and the first and second user ground stations 2a and 2b in the first QKD methodology is the BBM92 protocol. The communication channel 4 may, for example, be an optical or radio communications channel, a telecommunications network, or the Internet.

It will be understood that in order to use the second QKD methodology it is necessary for the satellite 1 to have an optical link with both of the first and second user ground stations 2a and 2b simultaneously. This imposes geographical constraints on the locations of the first and second user ground stations 2a and 2b, for example, if the satellite 1 were in an orbit at around 700 km altitude the locations of the first and second user ground stations 2a and 2b on the earths surface could be separated by up to approximately 2000 km. Further, the second QKD methodology can only be used to deliver paired secure key data to two user ground stations 2, and cannot be extended to include further user ground stations.

An example of a third QKD methodology which may be used in operation of the satellite quantum key distribution system 100 is a modification of the first QKD methodology discussed above. In the third QKD methodology, when the first secure key data has been received at the first user ground station 2a, the first user ground station 2a generates an XOR of user encryption key data stored at the first user ground station 2a and the first secure key data, and sends this XOR to the satellite 1 using a classical (non-quantum) communications channel. The satellite 1 is then able to use the first secure key data and the received XOR data to derive the user encryption key data.

The satellite 1 then stores the derived user encryption key data together with the associated key handle and any metadata, in a key buffer of the second user ground station 2b, and reports this, and the number of bits of the user encryption key data which have been received, to the key management system 4.

The third QKD methodology then proceeds in the same way as the first QKD methodology described above, but with the user encryption key data taking the place of the first secure key data of the first QKD methodology, so that the user encryption key data may be supplied to other user ground stations 2 as necessary.

The third QKD methodology may be used to carry out quantum key distribution of a user encryption key between different user ground stations 2.

The example described above of the third QKD methodologies uses XOR operations to securely transfer encryption keys between the satellite 1 and ground user stations 2. In other examples the XOR operations may be replaced by an alternative encryption scheme. Preferably such an alternative encryption scheme is of the One-Time-Pad (OTP) type. Suitable alternative encryption schemes may include the use of modulo arithmetic. An example of a modulo arithmetic encryption scheme is of the type encrypting number A and B by (A,B)=(A+B) modulo C, and decrypting by (A,B)=(A−B) modulo C, where in some examples C=256. Another example of a modulo arithmetic encryption scheme is of the type where encrypt (A,B)=decrypt(A,B)=(−A−B) modulo C, which is a self-inverse, similarly to XOR. Other forms of modulo arithmetic encryption scheme may also be used.

In some examples the satellite quantum key distribution system 100 may additionally, or alternatively, use other QKD methodologies.

Commonly, each user ground station 2 will be associated with a single user or communication client of the quantum key distribution system 100. However, in some examples a single ground station 2 may be associated with, and provide encryption keys to, a number of users or communication clients.

Preferably, the communications channel(s) between the at least one ground control station 3 and the satellites 1 are encrypted communications channels. These encrypted communications channels may, for example, be radio channels or optical channels. In preferred examples the communications channel(s) may be protected by quantum encryption, as disclosed in WO2019/11594A1, the contents of which are incorporated herein by reference.

In the embodiment described above the user ground stations of the system supply encryption keys to users on a “pull” basis. That is, the formatted encryption keys are provided to users by the user ground stations in response to user requests for encryption keys. In other examples the user ground stations may supply encryption keys to users on a “push” basis, such as providing encryption keys to users on a predetermined schedule or providing encryption keys to users immediately they are available at the user ground stations. In some examples some users of the system may be provided with encryption keys on a “pull” basis, while other users are provided with encryption keys on a “push” basis.

In the above examples the key buffers are key data stores.

In the examples illustrated in FIGS. 7 and 8 only a single satellite is used. These examples could be extended to systems 100 using multiple satellites 1.

In the embodiment described above the satellite quantum key distribution system 100 comprises a constellation of satellites 1. This constellation may comprise any number of satellites. Specifically, the constellation may comprise a single satellite 1.

In the embodiment described above the satellite quantum key distribution system 100 comprises a constellation of satellites 1. In some examples the constellation of satellites may include satellites having different capabilities, for example different optical communications capabilities and/or a capability to support different QKD methodologies.

In the embodiment described above the satellite quantum key distribution system 100 comprises a number of user ground stations 2. This may be a large number of user ground stations 2, for example 10,000 or more.

In the embodiment described above the volume of encryption key data is referred to. In other examples the number of encryption keys may be monitored and responded to instead of the data volume.

In the embodiment described above the at least one ground control station is located at a high latitude. In other examples the at least one ground control station may be located elsewhere, but this will generally reduce the efficiency of the system by requiring a greater number of ground control stations and/or increasing the length of time between successive passes of each satellite over the at least one ground control station.

In the embodiments described above the satellite quantum key distribution system comprises one or more satellites are located in Low Earth Orbit (LEO). In some alternative arrangements, the satellite quantum key distribution system may comprise one or more satellites placed in LEO while at least one other satellite is placed in Medium Earth Orbit (MEO) or in High Earth Orbit (HEO).

In the embodiments described above the satellite quantum key distribution system comprises one or more satellites are located in inclined polar orbits. In some alternative arrangements, one, some, or all of the satellites may be located in different orbits. In some alternative arrangements one, some, or all of the satellites may be in GEO, MEO or non-polar LEO orbits.

In the embodiments described above the system is a satellite quantum key distribution system. In other examples other cryptographic items could be distributed/delivered in addition to, or as an alternative to, encryption keys. Examples of such other cryptographic items include cryptographic tokens, cryptographic coins, or value transfers.

In the embodiments described above a classical (non-quantum) communication channel or link is provided between a satellite and a user ground station. In the embodiments described above this classical (non-quantum) communication channel or link may be provided by an optical communications channel or link between the satellite and the user ground station. In other examples the classical (non-quantum) communication channel or link may be provided by other forms of communications channel or link, for example by a radio communications (RF) channel or link. In some examples a classical (non-quantum) communication channel or link may be provided between a satellite and a user ground station by using one or more other user ground stations as relays. In such examples messages may be passed between user ground stations using any communication links, for example an optical fiber link, a telecommunications network, or the Internet, this list is not intended to be exhaustive.

The embodiments described above are fully automatic. In some examples a user or operator of the system may manually instruct some steps of the method to be carried out.

In the described embodiments of the invention parts of the system may be implemented as a form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Although illustrated as a single system, it is to be understood that a computing device may be a distributed system. Thus, for instance, several devices may be in communication by way of a network connection and may collectively perform tasks described as being performed by the computing device. Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-86. (canceled)

87. A method of scheduling and managing key data in a satellite quantum key distribution system comprising a constellation of one or more satellites and a plurality of user ground stations, the method comprising:
using a satellite of the constellation of satellites to deliver key data to a user ground station using a quantum communication link;
at the user ground station, storing the delivered key data and reporting the amount of delivered key data;
using the satellite to deliver key data to at least one other user ground station requiring common encryption keys with the user ground station using a respective quantum communication link;
at each other user ground station, storing the delivered key data and reporting the amount of delivered key data;
based upon the reports, determining an amount of the delivered key data which is commonly stored at all of the user ground station and the at least one other user ground station; and
instructing the user ground station and the at least one other user ground station to release the commonly stored delivered key data.

88. The method as claimed in claim 87, wherein the determining an amount of the delivered key data which is commonly stored at all of the user ground station and the at least one other user ground station is carried out at a key management system.

89. The method as claimed in claim 87, wherein, when the satellite of the constellation of satellites delivers key data to the user ground station the satellite stores a copy of the key data on the satellite.

90. The method as claimed in claim 89, wherein the satellite uses the copy of the key data stored on the satellite to deliver key data to at least one other user ground station.

91. The method as claimed in claim 89, wherein, when the satellite has delivered key data which is commonly stored at all of the user ground station and the at least one other user ground station, the satellite deletes the commonly stored key data from the copy of the key data on the satellite.

92. The method as claimed in claim 87, wherein the key data delivered to a user ground station comprises blocks of data, each block being assigned a unique identifier, and the reporting the amount of delivered key data comprises reporting the unique identifier of each received block together with metadata associated with the unique identifier which identifies the total size of the block.

93. The method as claimed in claim 92, wherein the metadata associated with the unique identifier also identifies the status of the block.

94. The method as claimed in claim 92, wherein each block is assigned the unique identifier by the user ground station; or
wherein each block is assigned the unique identifier by the satellite.

95. The method as claimed in claim 92, wherein reporting the amount of delivered key data at each other user ground station comprises reporting the unique identifier of each at least partially received block together with metadata associated with the unique identifier which identifies the total size of the block and the current amount of the block stored at that other user ground station.

96. The method as claimed in claim 87, wherein each of the user ground station and the at least one other user ground station respond to the instruction to release the commonly stored delivered key data by formatting the commonly stored data into formatted keys and releasing the formatted keys.

97. The method as claimed in claim 87, wherein the key data is delivered to the user ground station and one other user ground station by a methodology comprising:
forming quantum optical communication links from the satellite to the user ground stations and the other user ground station to send respective photons of entangled pairs to each of the user ground station and the other user ground station;
detecting the quantum information of the respective photons at each of the user ground station and the other user ground station; and
conducting an encryption key agreement process between user ground station and the other user ground station using the detected quantum information to determine key data.

98. The method as claimed in claim 87, wherein the key data is delivered to the user ground station and to the at least one other user ground station by a methodology comprising:
generating a first string of random numbers on the satellite;
using the first string of random numbers to form a first quantum optical communication link from the satellite to the user ground station;
conducting an encryption key agreement process between the satellite and the user ground station using the first string of random numbers to determine the key data;
storing the key data on the satellite;
and subsequently:
generating a second string of random numbers on the satellite;
using the second string of random numbers to form a second quantum optical communication link from the satellite to one of the at least one other user ground stations;
conducting an encryption key agreement process between the satellite and the one of the at least one other user ground stations using the second string of random numbers to determine second key data;
sending one-time-pad “OTP” data of an OTP operation of the key data and the second key data from the satellite to the one of the at least one other user ground stations;
using the second key data and the OTP data to derive the key data at the one of the at least one other user ground stations.

99. The method as claimed in claim 98, wherein the methodology further comprises subsequently:
generating a further string of random numbers on the satellite;
using the further string of random numbers to form a further quantum optical communication link from the satellite to a further one of the at least one other user ground stations;
conducting an encryption key agreement process between the satellite and the further one of the at least one other user ground stations using the further string of random numbers to determine further key data;
sending OTP data of an OTP operation of the key data and the further key data from the satellite to the further one of the at least one other user ground stations;
using the further key data and the OTP data to derive the key data at the further one of the at least one other user ground stations.

100. The method as claimed in claim 87, wherein satellites of the constellation are able to use multiple methodologies to deliver key data.

101. The method as claimed in claim 87, wherein the constellation of satellites comprises one satellite or multiple satellites.

102. The method as claimed in claim 87, and further comprising, after using the satellite to deliver key data to at least one other user ground station requiring common encryption keys with the user ground station using a respective quantum communication link, harvesting a portion of the delivered key data for utilization in internal security functions associated with the delivery.

103. The method as claimed in claim 102, wherein the harvesting a portion of the delivered key data comprises the satellite and the at least one other user ground station retaining a portion of the key data, such retained key data not being available for release by the user ground station and the at least one other user ground station.

104. The method as claimed in claim 103, wherein the retained key data is used to provide authentication and encryption for current and future quantum key delivery.

105. A satellite quantum key distribution system comprising a constellation of one or more satellites and a plurality of user ground stations, the system comprising:
a satellite of the constellation of satellites arranged to deliver key data to a user ground station using a quantum communication link;
a user ground station arranged to store the delivered key data and report the amount of delivered key data;
wherein the satellite is further arranged to deliver key data to at least one other user ground station requiring common encryption keys with the user ground station using a respective quantum communication link; and
each at least one other user ground station is arranged to store the delivered key data and report the amount of delivered key data; and
the system further comprising means arranged to, based upon the reports, determine an amount of the delivered key data which is commonly stored at all of the user ground station and the at least one other user ground station; and
instruct the user ground station and the at least one other user ground station to release the commonly stored delivered key data.

106. A computer-readable medium comprising code or computer instructions stored thereon, which when executed by a processor unit, causes the processor unit to perform the computer-implemented method according to claim 87.
